(19) United States
(12) Patent Application Publication
(10) Pub. No.: US 2026/0019425 A1
(43) Pub. Date: Jan. 15, 2026

(54) Systems and Methods for Providing Continuous Cybersecurity Readiness Using Artificial Intelligence Agents

(71) Applicant: Cygnvs Inc., Los Altos, CA (US)

(72) Inventors: Kevin Gaffney, Dublin (IE); Arvind Parthasarathi, Los Altos, CA (US); Yuli Mitsner, Toronto (CA); Karthick Kumar, Madurai (IN); Jing Yuan Wang, Toronto (CA)

(21) Appl. No.: 19/338,959

(22) Filed: Sep. 24, 2025

Related U.S. Application Data
(63) Continuation-in-part of application No. 18/955,608, filed on Nov. 21, 2024.
Application No. 18/955,608 is a continuation-in-part of application No. 17/939,865, filed on Sep. 7, 2022, now Pat. No. 12,166,768.
Application No. 17/939,865 is a continuation of application No. 17/476,367, filed on Sep. 15, 2021, now Pat. No. 11,477,208.

(51) Int. Cl. H04L 9/40; G06F 16/22; G06Q 10/101

(52) U.S. Cl. CPC H04L 63/105; G06F 16/2246; H04L 63/0853; G06Q 10/101

(57) ABSTRACT

Systems and methods for providing continuous cybersecurity readiness are disclosed. An exemplary method begins with ingesting user data and an entity playbook. An adversary AI agent generates a cybersecurity threat scenario that is customized for the user. A digital collaboration room is established for an entity, where the entity has control to grant and modify permissions to a user and artificial intelligence (AI) agents regarding the digital collaboration room. User responses to one or more questions posed in the threat scenario are received, evaluated and analyzed by a user agent AI in real-time. The readiness of the user to respond to a cybersecurity threat and the effectiveness of the playbook are evaluated. Feedback is generated about the playbook. Finally, the playbook of the entity is updated, which includes incorporation of the generated feedback.

### CROSS-REFERENCE TO RELATED APPLICATIONS

This application is a continuation-in-part of U.S. application Ser. No. 18/955,608, filed on Nov. 21, 2024, titled “Systems and Methods for Facilitating Tabletop Exercises Using Collaboration Rooms with Dynamic Tenancy”, which is a continuation-in-part of U.S. application Ser. No. 17/939,865, filed on Sep. 7, 2022, titled “Systems and Methods of Entity Control of Collaboration Rooms”, now U.S. Pat. No. 12,166,768, issued on Dec. 10, 2024, which is a continuation of U.S. application Ser. No. 17/476,367, filed on Sep. 15, 2021, now U.S. Pat. No. 11,477,208, issued on Oct. 18, 2022, titled “Systems and Methods for Providing Collaboration Rooms with Dynamic Tenancy and Role-based Security”, all of which are hereby incorporated by reference herein in their entireties, including all references and appendices cited therein, for all purposes, as if fully set forth herein.

This application is also related to U.S. application Ser. No. 16/940,272, filed on Jul. 27, 2020, now U.S. Pat. No. 11,526,825, issued on Dec. 13, 2022, titled “Cloud-Based Multi-Tenancy Computing Systems and Methods for Providing Response Control and Analytics”, U.S. application Ser. No. 17/477,384, filed on Sep. 16, 2021, now U.S. Pat. No. 11,354,430, issued on Jun. 7, 2022, titled “Systems and Methods for Dynamically Establishing and Managing Tenancy Using Templates”, and U.S. application Ser. No. 18/196,967, filed on May 12, 2023, now U.S. Pat. No. 12,015,617, issued on Jun. 18, 2024, titled “Systems and Methods for Providing Secure Access to Collaboration Rooms with Dynamic Tenancy in Response to an Event”, all of which are hereby incorporated by reference herein in their entireties, including all references and appendices cited therein, for all purposes, as if fully set forth herein.

### FIELD OF THE PRESENT TECHNOLOGY

The present disclosure pertains to systems and methods for providing continuous cybersecurity readiness utilizing artificial intelligent agents and multilayered feedback loops. In certain embodiments, such systems and methods are performed using digital collaboration rooms having dynamic tenancy.

### SUMMARY

Some embodiments of the present disclosure are directed to a method for providing continuous cybersecurity readiness using artificial intelligence, comprising: ingesting user data associated with the user and a playbook associated with the entity; based on the user data and the playbook, generating, by the adversary AI agent, a cybersecurity threat scenario that is customized for the user; receiving user responses to one or more questions posed in the threat scenario; establishing, via an orchestration service, a digital collaboration room for an entity, the entity having control to grant permissions to a user and artificial intelligence (AI) agents regarding the digital collaboration room and to dynamically modify permissions of the user and the AI agents, the orchestration service being a cloud resource where the digital collaboration room, owned by the entity, is hosted and made accessible to the user and the AI agents, the AI agents comprising an adversary AI agent and a user agent AI; evaluating and analyzing the user responses by the user agent AI in real-time; based on the AI evaluation and analysis of the user responses, evaluating readiness of the user to respond to a cybersecurity threat; evaluating effectiveness of the playbook and generating feedback regarding the playbook, the feedback being generated from one or more feedback loops between the AI agent and the user; and updating the playbook, the updating including incorporation of the generated feedback into the playbook.

Further embodiments of the present disclosure are directed to a method for providing continuous cybersecurity readiness using artificial intelligence, comprising: ingesting and processing user data associated with the user, a playbook associated with the entity, and threat data obtained from external sources; analyzing processed threat data; based on the user data and the playbook, generating, by the adversary AI agent, a cybersecurity threat scenario that is customized for the user; receiving user responses to one or more questions posed in the threat scenario; evaluating and analyzing the user responses by the user agent AI in real-time; establishing, via an orchestration service, a digital collaboration room for an entity, the entity having control to grant permissions to a user and artificial intelligence (AI) agents regarding the digital collaboration room and to dynamically modify permissions of the user and the AI agents, the orchestration service being a cloud resource where the digital collaboration room, owned by the entity, is hosted and made accessible to the user and the AI agents, the AI agents comprising an adversary AI agent and a user agent AI; based on the AI evaluation and analysis of the user responses, generating real-time guidance by the user agent AI; evaluating readiness of the entity, the user, or a team associated with the user to respond to a cybersecurity threat; generating feedback from multi-layered feedback loops; evaluating effectiveness of the playbook and generating feedback regarding the playbook, the feedback being generated from one or more feedback loops of the multi-layered feedback looks; and updating the playbook using the generated feedback.

One aspect of the present disclosure is directed to a system for a processor and memory for storing executable instructions, the processor executing the instructions to: ingest user data associated with the user and a playbook associated with the entity; based on the user data and the playbook, generate, by the adversary AI agent, a cybersecurity threat scenario that is customized for the user; receive user responses to one or more questions posed in the threat scenario; establish, via an orchestration service, a digital collaboration room for an entity, the entity having control to grant permissions to a user and artificial intelligence (AI) agents regarding the digital collaboration room and to dynamically modify permissions of the user and the AI agents, the orchestration service being a cloud resource where the digital collaboration room, owned by the entity, is hosted and made accessible to the user and the AI agents, the AI agents comprising an adversary AI agent and a user agent AI; evaluate and analyze the user responses by the user agent AI in real-time; based on the AI evaluation and analysis of the user responses, evaluate readiness of the user to respond to a cybersecurity threat; evaluate effectiveness of the playbook and generating feedback regarding the playbook, the feedback being generated from one or more feedback loops between the AI agent and the user; and update the playbook, the updating including incorporation of the generated feedback into the playbook.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 depicts an example architecture where the systems and methods of the present disclosure can be implemented.

FIG. 2 illustrates an example tree structure for use in a hierarchical permissions analysis.

FIG. 3 is a flowchart of an example method of the present disclosure.

FIG. 4 is a flowchart of an example method of the present disclosure related to an example hierarchical permissions analysis.

FIG. 5 is a flowchart of an example method of the present disclosure.

FIG. 6 is a schematic diagram of a computing system that is used to implement embodiments according to the present technology.

FIG. 7 is a flowchart of an example method for facilitating tabletop exercises.

FIGS. 8A and 8B are flowcharts of example methods of the present disclosure related to facilitating tabletop exercises and providing feedback.

FIGS. 9A and 9B are flowcharts of an example method related to facilitating tabletop exercises using collaboration rooms with dynamic tenancy.

FIGS. 10A and 10B are exemplary screenshots of a facilitator's dashboard user interface during a tabletop exercise.

FIGS. 11A and 11B are exemplary screenshots of a participant's dashboard user interface during a tabletop exercise.

FIG. 12 depicts an exemplary dynamic system for continuous cybersecurity readiness.

FIG. 13 is a flowchart of an example method of the present disclosure.

FIG. 14 is a workflow diagram of an exemplary system of the present disclosure.

FIGS. 15A and 15B are flowcharts of an example method of the present disclosure.

FIG. 16 is an exemplary screenshot of a Chief Information Security Officer (CISO)'s readiness dashboard user interface, in accordance with certain embodiments of the present disclosure.

FIG. 17 is an exemplary screenshot of a graphical user interface that is displayed when a new drill is scheduled, in accordance with certain embodiments of the present disclosure.

FIG. 18 is an exemplary screenshot of a graphical user interface that is displayed when results of a drill are viewed, in accordance with certain embodiments of the present disclosure.

FIG. 19 is an exemplary screenshot of an end user (participant)'s dashboard user interface, in accordance with certain embodiments of the present disclosure.

FIG. 20 is an exemplary screenshot of a graphical user interface that is displayed when an end user starts a drill, in accordance with certain embodiments of the present disclosure.

FIGS. 21A, 21B and 21C are exemplary screenshots of a virtual assistant, in accordance with certain embodiments of the present disclosure.

FIG. 22 is a schematic diagram of a computing system that is used to implement embodiments according to the present technology.

### DETAILED DESCRIPTION

### Overview

Broadly, the present disclosure is directed to systems and methods for facilitating tabletop exercises (also referred to as “TTX”) using collaboration rooms with dynamic tenancy. Entities use tabletop exercises as a role-playing activity or a simulation, in order to measure the effectiveness of their incident response (IR) plan. Tabletop exercises are usually discussion-based sessions where teams meet in a classroom setting to discuss their roles and responses or plan of action during an incident or a crisis. A facilitator of the tabletop exercise can help guide participants through one or more incident or crisis scenarios. A facilitator can also moderate discussions about how to address such scenarios.

Current tabletop exercises fail to simulate actual incidents, and oftentimes current tabletop exercises make use of the entity's tools (or organizational tools) which may not be available to participants of the tabletop exercises during a crisis. Indeed, most entities oftentimes provide disparate resources to participants (or users) for the facilitation of tabletop exercises. Those disparate resources may or may not be available to those participants during a crisis, such as a cyber crisis. For example, most entities have only an organization account or a business account, which a participant may not be able to access. This poses many access problems and obstacles to participants who desire to participate in tabletop exercises. Furthermore, traditional incident response plans and tabletop exercises often do not co-exist within a single platform. Thus, entities can find it challenging to incorporate feedback from a given tabletop exercise into a specific incident response plan and amend that incident response plan for future use.

The present disclosure addresses these problems and more, by providing organizations with a single out-of-band (OOB) platform as a means for hosting and collaborating on incident response plans. Specifically, the present disclosure allows for a tabletop exercise to be conducted using the exemplary platform, where users (including facilitators) can provide their incident response plans and collaborate with all the stakeholders that are required for an incident response. Users can utilize the conferencing facility present within the application to run the incident simulation in real time. By allowing the tabletop exercise to run within the platform, users can experience firsthand the issues that arise from a given incident (such as a cyber crisis) and can role-play or otherwise reenact the exact steps that should be taken while responding to the incident. Over time, the incident response plan upon which the users run tabletop exercises will be refined, based on the inputs that the system captures as part of the tabletop exercises and the outcomes of the tabletop exercises. Furthermore, a tabletop exercise can be accompanied by an after-action report which can then be used to refine the incident response plan.

In summary, the present disclosure describes the exemplary systems and methods for conducting or facilitating tabletop exercises that mimic real-life incidents, such as cyber crises, by using a single out-of-band platform. By facilitating tabletop exercises, the exemplary systems and methods described herein allow for users to practice, amend and refine an incident response plan with the assistance of the platform, while training participants or users on how to respond to a specific incident in accordance with the incident response plan. In other words, the systems and methods described herein measure effectiveness of incident response plans and participants' preparedness to crisis scenarios.

### Example Embodiments

Collaboration Rooms with Dynamic Tenancy

Broadly, the present disclosure is directed to systems and methods for establishing and managing digital collaboration rooms. A plurality of digital collaboration rooms can be established for a plurality of entities, such as companies. A collaboration room can be established to allow users to access data pertaining to an event, such as a lawsuit or a data breach. Users may be associated with the entity or a vendor who may assist the entity with respect to the event. For example, a vendor can include a law firm, a lawyer, privacy counsel, technology consulting, credit monitoring, brokers, public relations, insurance, and notification services-just to name a few. While some embodiments involve creating a collaboration room or other similar virtual collaboration environment based on an event, such spaces can be created for purposes of group collaboration without being connected to or initiated by an event.

The systems and methods provide an orchestration service where entities can maintain collaboration rooms. The orchestration service can also include vendor accounts or profiles. Entities can select vendors to invite to their collaboration room(s). Vendors can access the collaboration room(s) of one or more entities through the orchestration service, and access data depending on their particular permissions or rights granted to them by the entity.

In some instances, many users may need to access data inside the collaboration room and each of these users may have different permissions with respect to the data. The systems and methods can maintain roles that specify the permissions for each user. In one embodiment, the permissions can be modified, resulting in real-time or near-real-time changes to the role of the user. Indeed, the entity is provided with complete control of users that are allowed to enter the collaboration room, as well as what actions the users are allowed to perform on the data inside the collaboration room. In some instances, the permissions for the user, as well as what collaboration rooms they can enter can be encoded into a token.

The systems and methods can perform a hierarchical permissions analysis as users request actions within a collaboration room. In some instances, each time a user performs an action inside the collaboration room, such as refreshing, view, edit, delete, or other similar actions, a hierarchical permissions analysis is executed to determine if the user has permission to perform the requested action, as well as if the user has access rights to be in the collaboration room. This hierarchical permissions analysis can be used to effectuate the dynamic tenancy aspects disclosed herein, as will be discussed in greater detail herein.

Also, in some configurations, the systems and methods may obtain data from a database and allow actions to be performed on the data inside the collaboration room. These data are not maintained in a cache or preserved locally. Thus, access to the data is controlled and actions can only be performed on the data in the collaboration room by an authorized user.

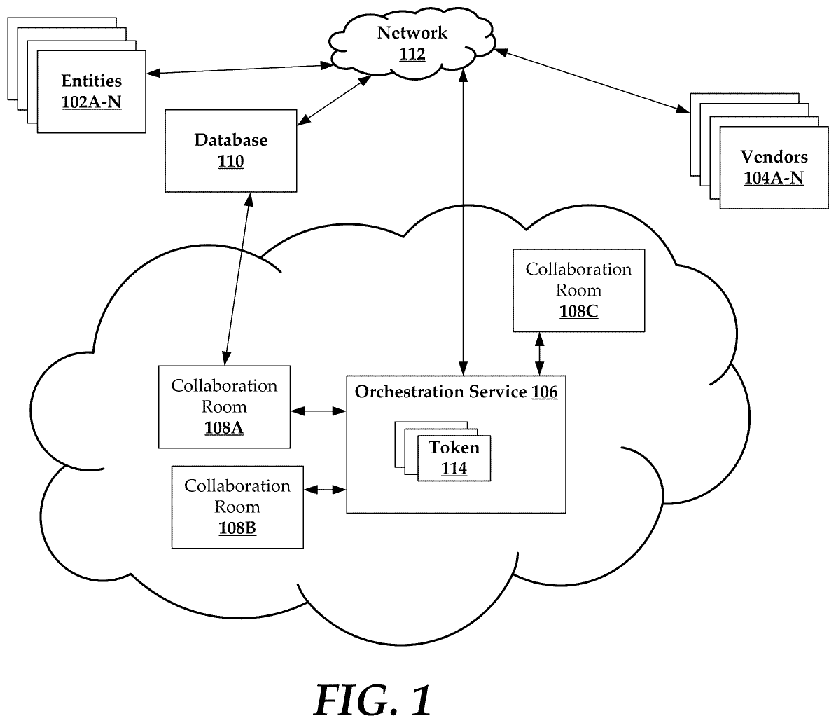

FIG. 1 illustrates an example architecture where aspects of the present disclosure can be performed. The architecture may include a plurality of entities, such as entities 102A-N, a plurality of vendors, such as vendors 104A-N, and an orchestration service 106. These components can communicate with one another over a network 112. In general, the architecture creates a global network of users, both entity-related and vendor-related, who can access digital collaboration rooms. Vendors or service providers can publish service-related information. The orchestration service can allow the vendors to be selectable by the plurality of entities.

The entities can also request the creation of collaboration rooms. For example, entity 102A can establish collaboration rooms 108A and 108B, while another entity can establish collaboration room 108C. Entities can control when and how vendors access these collaboration rooms, as well as what kinds of actions the users can perform against data obtained from a database 110. As will be discussed herein, data can be pulled from the database 110 on an as-needed basis. In some embodiments, data does not persist in a collaboration room beyond a session with one or more vendors.

The network 112 can include combinations of networks that enable the components in the architecture to communicate with one another. The network 112 may include any one or a combination of multiple different types of networks, such as cellular, cable, the Internet, wireless networks, and other private and/or public networks. In some instances, the network 112 may include Wi-Fi or Wi-Fi direct. The network 112 can include short-range or radiofrequency links such as BLUETOOTH or ultra-wideband (UWB).

The orchestration service 106 can allow an entity to establish a collaboration room. The digital collaboration room can be configured to allow users to perform actions on data obtained from a database and placed into the digital collaboration room. For example, entity 102A can establish collaboration rooms 108A and 108B, where collaboration room 108A pertains to a first event, such as a cybersecurity breach, and collaboration room 108B, which pertains to a ransomware event. In general, collaboration rooms can be created in response to an incident or event (although in some instances rooms are not created in response to an event, but simply to allow users to collaborate). The orchestration service 106 can assign each entity a tenant identifier. The orchestration service 106 can assign each collaboration room a digital collaboration room identifier.

There are two types of users on the entity side (additional roles can also be specified). For example, entity users can have an administrator role or a participant role. These users are typically employees who help the entity navigate an event. The entity can invite any of the vendors to access a particular collaboration room.

When an entity chooses a vendor from the global network of users, the orchestration service 106 can generate a token 114 for the vendor user. The token 114 can embed a set of long-lived credentials that allow a user to perform an action on data with respect to a tenant (specified by a tenant ID), for a particular collaboration room (specified by a digital collaboration room ID). By long-lived, this means that privileges/permissions can persist until revoked by a user who has the right to revoke permissions. It will be understood that some privileges or credentials can be short-lived as well. For example, some privileges or credentials can be set to expire after a period of time or after a certain number of uses. A user could be allowed to view a document a set number of times, or until the expiration of a date in the future.

Also, when vendor users have been granted access to collaboration rooms of various entities, the orchestration service 106 can allow vendors to enter and exit collaboration rooms as needed. The orchestration service 106 effectively functions as a cloud resource where collaboration rooms, owned by entities, can be hosted and made accessible to vendors.

The token 114 can include any one or more of a tenant identifier, a digital collaboration room identifier, an access right for the user to enter the digital collaboration room, and a role for the user. Generally speaking, the role specifies a set of permissions that indicate actions that can be performed by the user within the collaboration room. For example, a user who is a lawyer may be given a first set of permissions, whereas an insurance broker may be given a second set of permissions. The lawyer may be allowed to access and view any type of document, while the insurance broker may be allowed to access and view only data related to an insurance claim.

While some examples include roles that can be assigned on an individual user level, the orchestration service 106 also allows for the creation of higher-level user roles. For example, a general law firm role can be established which allows any user in the law firm to perform certain actions in the collaboration room.

The orchestration service 106 allows entities to specify what permissions are created for given roles. For example, a lawyer role can include a role with a set of permissions that allows the user to view all data, as well as other actions such as edit, delete, move, and so forth. Again, the orchestration service 106 allows actions to be performed on data placed in a collaboration room. The actions can include, but are not limited to read, view, write, filter, edit, and so forth. For each action, there is a specific and defined permission that can be grated and encoded into a token for the user. In some instances, the permissions are selected by an administrative user of the entity which owns the digital collaboration room.

Additionally, the orchestration service 106 can allow entity administrator users the ability to set visibility of actions within the collaboration room. For example, the administrator may allow all users to see all actions that can be conducted in the collaboration room. In another embodiment, only users internal to an entity can view the actions that are available in the collaboration room. In yet another example, only people listed in a lead of the user section may be allowed to view actions in the collaboration room. For example, a head lawyer or technical specialist may be allowed to view actions, while others on their team may not. In sum, a user may have all or limited view into actions available in the collaboration room.

In some instances, the orchestration service 106 can email a requested vendor a link. The user can click the link to enter the digital collaboration room. For example, the vendor 104A can enter the collaboration room 108A of entity 102A. The orchestration service 106 can evaluate the token of the user to determine if they have permission to enter the collaboration room 108A. In some instances, the token can be linked to a session policy for the user. That is, the actions of the user can be managed on a session-by-session basis.

Once the user enters collaboration room 108A, the user can perform an action on data obtained from the database 110. For example, the vendor may request to view emails regarding a particular topic. In some instances, the orchestration service 106 can provide a query interface where the vendor can query for documents or other data using dropdown boxes, fields, or other input mechanisms.

If there are data responsive to the query, these data can be obtained from the database 110 and made available in the collaboration room 108A. The user can then be allowed to perform one or more actions against the data, assuming the user has permissions for such actions. Thus, the orchestration service 106 can be configured to receive a request to perform an action on a portion of the data. That is, in some instances, the user can perform an action on all or a portion of the data included in the database 110.

The orchestration service 106 can maintain dynamic tenancy within the architecture. Dynamic tenancy allows for the permissions/role of a user to be updated at any time and to have these modifications to the permissions/role become effective in real-time or near-real-time. These changes in permissions/role for a user can occur even in instances where the user is active in the collaboration room. An administrator user for an entity can change the permissions for a vendor user at any time. For example, the permissions/role for a lawyer can be changed. The permissions may initially allow the lawyer to access all data/documents for the entity related to the incident or event associated with the collaboration room. Changes in these permissions may result in the lawyer being allowed to access only a portion of the data due to an identified conflict. In another example, a lawyer can be completely excluded as well, based on an identified conflict. While examples herein contemplate the entity having administrators that can change permissions, some vendor roles may also be allowed to edit permissions for subordinate vendor users. For example, a managing partner of a law firm can manage permissions assigned to individual lawyers in their firm.

As noted above, these permissions can be changed and effectuated in real-time. By way of example, when a user is in the collaboration room viewing documents, the user's permissions to view certain documents may be revoked. When the user attempts to refresh their view or open a document, the user will be blocked when the requested documents are in the portion of the data for which the permissions of the user have been revoked. The user can continue to operate in the collaboration room and perform other actions for which they have permission.

In some instances, the orchestration service 106 enables aspects of dynamic tenancy by performing continual permissions checks or analyses on users in the collaboration room. The orchestration service 106 can perform permissions checks any time a user performs or requests the performance of an action in the collaboration room. This can include actions such as refreshing a view of the collaboration room. In general, any behavior of a user in a collaboration room can be considered an action. Thus, an action is requested each time the user performs a refresh of the data in the digital collaboration room, or other similar actions.

For example, a user currently viewing a document may have their permission to view that document revoked. If the user refreshes their view or requests an action related to the document, access to that document can be revoked such that the user can no longer view or perform actions against that document. Again, as noted above, this can occur on a session-by-session basis, where permissions can be authorized for a session, and the permissions are rechecked in a subsequent session. Changes between sessions to the permissions can result in an alteration of user rights. In sum, an entity user or other authorized user can change the set of permissions which dynamically changes the role of the user, at any time.

To enable this dynamic tenancy and dynamic provision of permissions, the orchestration service 106 can be configured to perform a hierarchical permissions analysis. The hierarchical permissions analysis is a bottom-to-top permissions analysis that determines user who has requested an action has the requisite permission or right to perform the requested action. In some instances, the user can submit a request that requires more than one action. For example, a request to edit a document may include initially a request to obtain the document from the database, along with another request to allow the user to view the document, and finally a request to edit the document. Each of these requests may have a first permission associated therewith. The request to obtain could have a first permission, the request to view have a second permission, and the request to edit may have a third permission. In general, the third permission can depend on the user having the second permission, and the second permission can depend on the user having the first permission. This creates what is referred to as a dependency ordering of one or more actions.

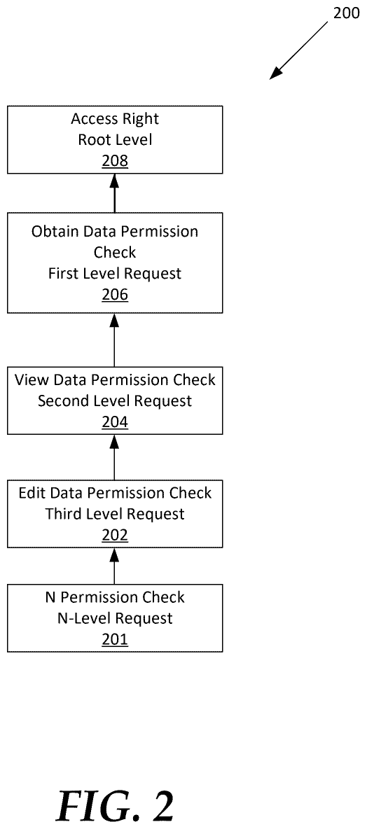

Referring now to FIGS. 1 and 2 collectively, generally, when more than one action is requested in a session, the actions can be considered as a tree structure 200. In one example, each of the one or more actions can be arranged into branches of a tree structure based on the dependency ordering. A third action would be on bottom level 202 of the tree structure, with the second action on a second level 204 above the third level, and the first action on a first level 206 above the second. A root level 208 of the tree structure can be the access right to the digital collaboration room. In general, each of the one or more actions are arranged into branches of a tree structure based on the dependency ordering, with the access right to the digital collaboration room being a root of the tree structure. While three levels have been shown, any N-number of levels of requests and permissions checks can be present (see 201 of FIG. 2).

In one example, an action or transaction can include either a read or write operation. To write, a user should possess permission to read and/or write from the bottom to the top of a tree structure. To read, a user should possess permission to read from the bottom to the top of a tree structure.

The orchestration service 106 can be configured to determine a dependency ordering of one or more actions related to the data. The hierarchical permissions analysis can include determining if the user has permission to perform each of the one or more actions, in a bottom-to-top manner based on the dependency ordering. Thus, when the user requests the third action of editing the document, the orchestration service 106 can determine if the user has permission to edit the document. Also, the orchestration service 106 also determines if the user has permission to view the document (second action), as well as permission to obtain the document (first permission). Finally, the orchestration service 106 also determines if the user currently has permission to enter the digital collaboration room.

These permissions checks occur in a layered fashion as well. For example, the user may first request only to obtain the document. A permissions check is then performed to ensure the user has the right to obtain the document. When the user then requests to open/view the document, the orchestration service 106 not only determines if they have permission to open/view the document, but the orchestration service 106 can again verify that the user has permission to obtain the document. The orchestration service 106 can also verify that the user currently has rights to be in the collaboration room at each separate permissions check. Thus, the orchestration service 106 can iteratively and/or recursively check for permissions at each level of the dependency ordering.

Again, these permissions checks are performed by the orchestration service 106 to ensure that none of the permissions have changed or been modified. For example, if the right of the user has been revoked to view the document, the user also cannot be allowed to edit the document. If the right of the user has been revoked to obtain the document, the user also cannot be allowed to view or edit the document. It will be understood that the user may still have rights to enter the digital collaboration room and conduct other actions. However, if the access rights of the user to enter the collaboration room have been revoked, the user can perform no actions.

The orchestration service 106 can deny access to all or a portion of the data when the role has been altered and the first user no longer has rights to perform the action. The orchestration service 106 can deny access to perform the action on the data when a permission of a set of permissions has been revoked but the user currently has permission to be in the digital collaboration room. In this example, the user can still be in the collaboration room and potentially be assigned other permissions. As noted above, this hierarchical permissions analysis can be executed each time a user performs any action inside the collaboration room. Also, the hierarchical permissions analysis is performed against the permissions in the token for the user. That is, the orchestration service 106 can convert the permissions into a set of rules that are run over data pulled from the database 110.

Assuming the user request passes the hierarchical permissions analysis, the orchestration service 106 can obtain data from a database and allow the one or more requested actions to be performed on the data.

In some embodiments, a tenant can be associated with one or more vaults (e.g., databases) that store data that can be used in a collaboration. A user can be associated with the tenant. The user can have a specified role, such as a provider/vendor role, a provider/administrator role, and/or a client role. These roles pertain to a collaboration room. A user can have vault roles as well, such as administrator role, a user role, and/or a vendor role. Thus, multiple users can have access to data in the vault. Each user can be allowed to perform one or more actions in a collaboration room related to data obtained from the vault inside the collaboration room.

A task can have n-number of associated tasks, messages, and/or facts. The user and data can have one or more visibility rules applied thereto. Example visibility rules can include, but are not limited to, allowing all users in the collaboration room to view data obtained from the vault, only allowing users internal to the entity to view data, and/or custom confidential users or organizations which can be explicitly added.

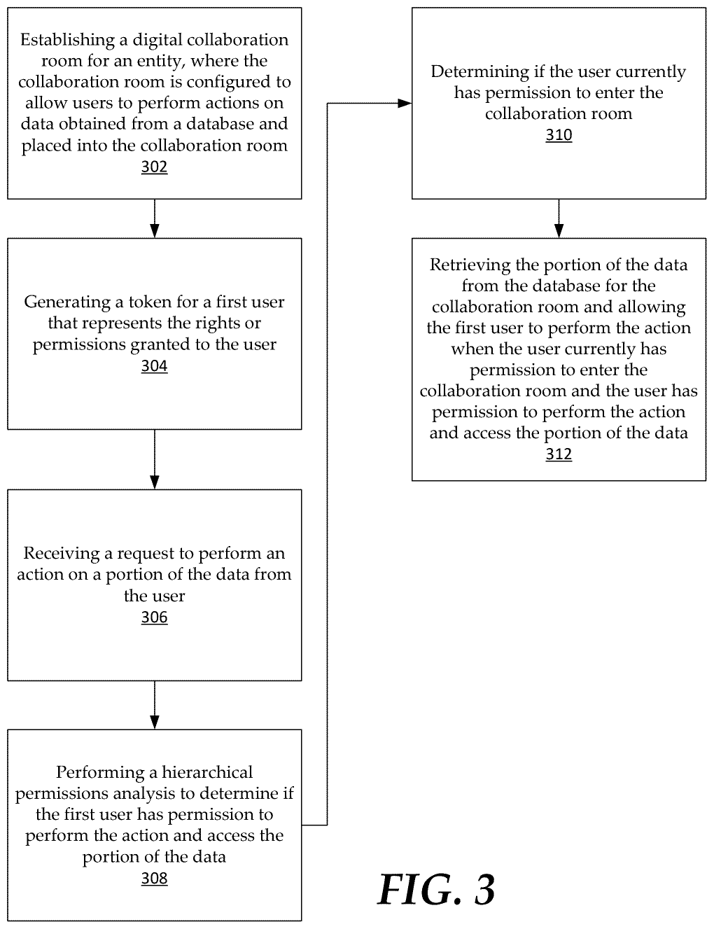

FIG. 3 is a flowchart of an example method of the present disclosure. The method can include a step 302 of establishing a digital collaboration room for an entity, where the digital collaboration room being configured to allow users to perform actions on data obtained from a database and placed into the digital collaboration room. In some instances, the entity and collaboration room are each given a unique ID.

Next, the method includes a step 304 of generating a token for a first user that represents the rights or permissions granted to the user. Generating the token may include encoding a tenant identifier, a digital collaboration room identifier, an access right for the first user to enter the digital collaboration room, and a role for the first user. To be sure, the role specifies a first set of permissions that indicate actions that can be performed by the first user.

Steps 302 and 304 can be performed for additional users. That is, a plurality of users can be granted tokens and corresponding permissions related to the collaboration room.

The method can include a step 306 of receiving a request to perform an action on a portion of the data from the user. For example, the user can submit a query to identify documents that are relevant to one or more keywords.

The method also includes a step 308 of performing a hierarchical permissions analysis to determine if the first user has permission to perform the action and access the portion of the data. The hierarchical permissions analysis can also include a step 310 of determining if the user currently has permission to enter the digital collaboration room. As noted above, this can include evaluating an access right included in the token for the user.

Assuming that the permissions analysis is successful, the method can include a step 312 of retrieving the portion of the data from the database for the digital collaboration room and allowing the first user to perform the action when the user currently has permission to enter the digital collaboration room and the user has permission to perform the action and access the portion of the data. If the permissions analysis is unsuccessful, the user can be presented with a message informing them that they lack permission to perform the requested action.

In some instances, the method can include specifying a role for the first user that includes a first set of permissions. The method can also include altering the first set of permissions and denying access to the portion of the data when the role has been altered and the first user no longer has rights to perform the action. Access to perform the action on the portion of the data can also be denied when a permission of the first set of permissions to perform the action has been revoked but the user currently has permission to be in the digital collaboration room. Thus, the access right may be intact and granted while permissions for dependent actions may be active or revoked.

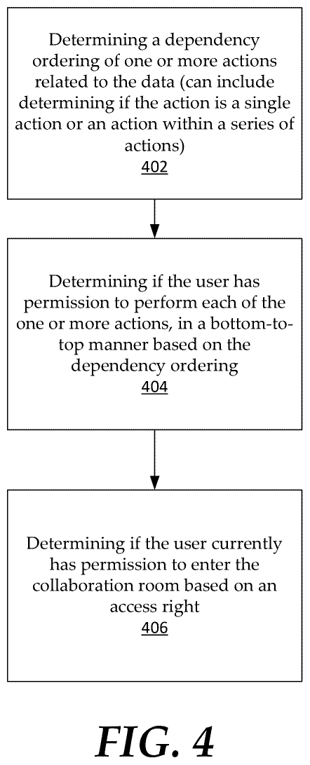

FIG. 4 is a flowchart of another example method for performing a hierarchical permissions analysis that includes a step 402 of determining a dependency ordering of one or more actions related to the data. This can include determining if the action is a single action or an action within a series of actions. When more than one action is occurring or has been requested, the method can include a step 404 of determining if the user has permission to perform each of the one or more actions, in a bottom-to-top manner (e.g., iteratively or recursively) based on the dependency ordering. Next, the method includes a step 406 of determining if the user currently has permission to enter the digital collaboration room based on an access right.

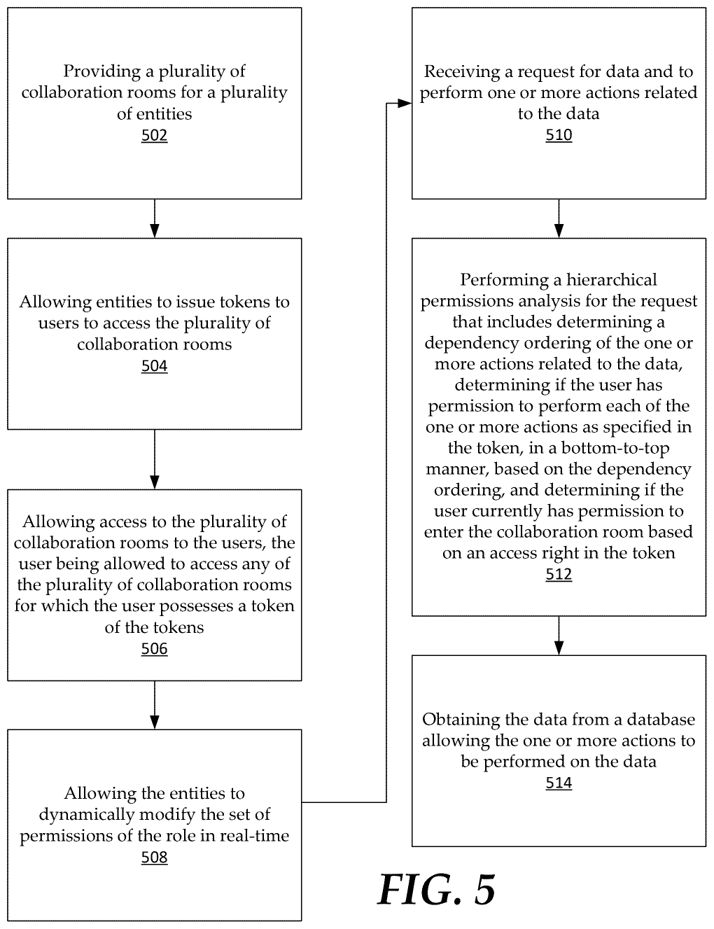

FIG. 5 is a flowchart of another example method of the present disclosure. The method can include a step 502 of providing a plurality of digital collaboration rooms for a plurality of entities. The method can also include a step 504 of allowing entities to issue tokens to users to access the plurality of digital collaboration rooms. Each user has been issued one of the tokens and each of the tokens comprises a tenant identifier that identifies one of the plurality of entities, a digital collaboration room identifier, and a role with a set of permissions.

The method includes a step 506 of allowing access to the plurality of digital collaboration rooms to the users, the user being allowed to access any of the plurality of digital collaboration rooms for which the user possesses a token of the tokens. Next, the method includes a step 508 of allowing the entities to dynamically modify the set of permissions of the role in real-time, as well as a step 510 of receiving a request for data and to perform one or more actions related to the data.

In some instances, the method can include a step 512 of performing a hierarchical permissions analysis for the request that includes determining a dependency ordering of the one or more actions related to the data, determining if the user has permission to perform each of the one or more actions as specified in the token, in a bottom-to-top manner, based on the dependency ordering, and determining if the user currently has permission to enter the digital collaboration room based on an access right in the token. Based on success of the hierarchical permissions analysis, the method includes a step 514 of obtaining the data from a database allowing the one or more actions to be performed on the data.

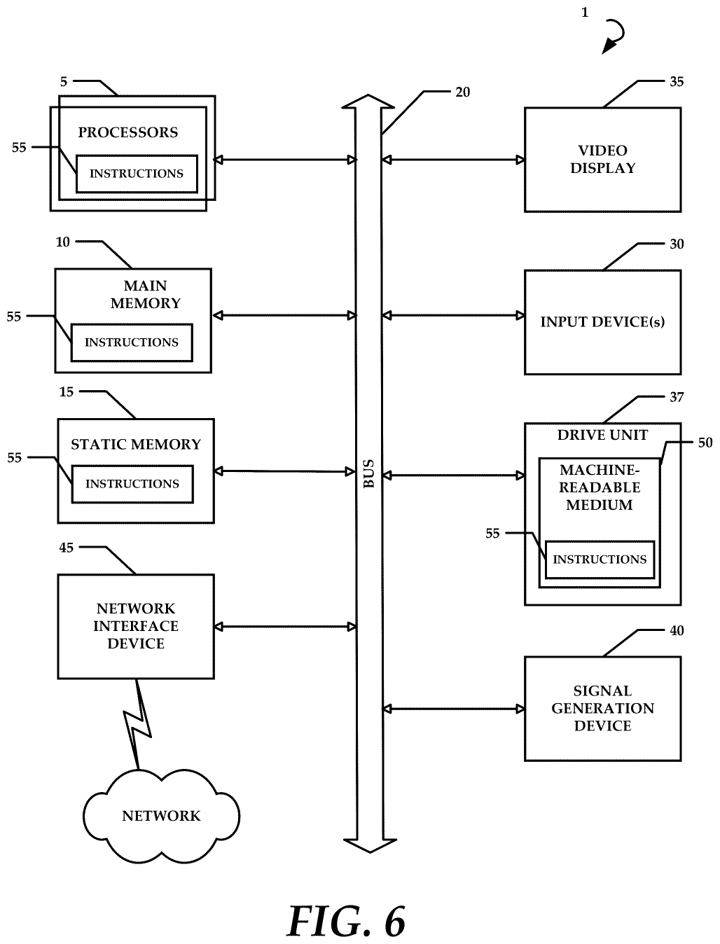

FIG. 6 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 are those typically found in computer systems that may be suitable for use with embodiments of the present disclosure and are intended to represent a broad category of such computer components that are well known in the art. Thus, the computer system 1 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

### Facilitating Tabletop Exercises

As mentioned earlier, the exemplary system or platform is designed for conducting simulation exercises (also called tabletop exercises) in a secure manner using secure communication channels. As an example, the platform can be used by IT or security teams to collaborate with business teams and external providers. In certain embodiments, the platform is designed to be used by any stakeholder, and the platform can be a vehicle for dynamically hosting incident response plans and playbooks. Also, the platform can be a means for incident reporting for regulatory compliance. The platform can be utilized by an entity to run realistic crisis response exercises, and it allows for an entity to assess gaps and improve incident response plans. By facilitating tabletop exercises using the exemplary platform, the participants can improve their crisis response awareness and decision making on behalf of the entity. The tabletop exercises may also assist participants in understanding the regulatory response requirements and for participants to understand their role and responsibilities, in the event that a real-life incident or crisis takes place. Finally, the platform is a means for testing communications and external coordination with business teams, external providers, and other stakeholders should an incident occur.

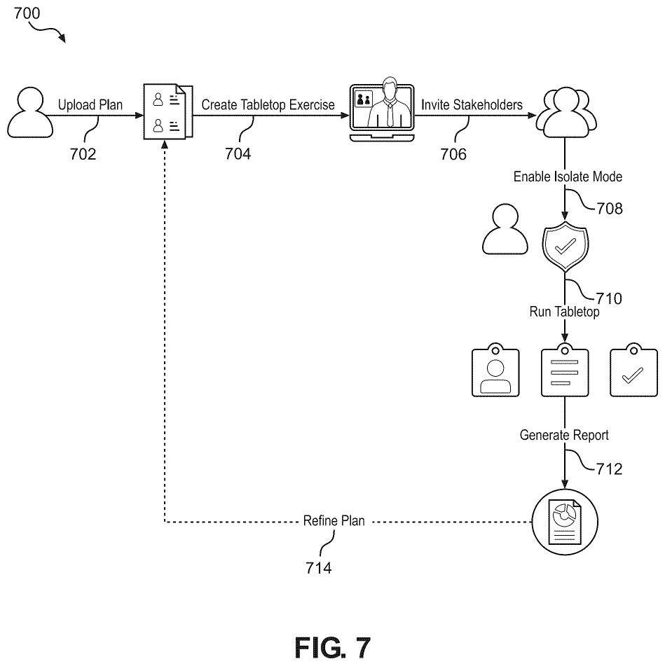

FIG. 7 illustrates a method 700 for facilitating tabletop exercises using an exemplary out-of-band single platform. The exemplary platform can be implemented using the systems and methods embodiments described earlier herein, including, for example, the exemplary architecture of FIG. 1 and the computing system of FIG. 6. As discussed previously, in some embodiments, the exemplary platform can be separate from an entity's compromised and possibly disparate infrastructure platforms that may have been affected by an incident, such as a cyberattack.

Referring again to FIG. 7, the method 700 begins with step 702, when an entity or a user on behalf of an entity (such as a facilitator user) uploads an incident response (IR) plan onto the exemplary platform or system. As mentioned earlier, a facilitator (also known as a faciliator user) of the tabletop exercise can help guide participants of the tabletop exercise through one or more incident or crisis scenarios. Such scenarios are oftentimes simulations of real-life crises, such as cyberattacks. During the tabletop exercise, a facilitator can moderate discussions about how to address such scenarios, so that the participants can participate and respond to the scenarios as if the scenario is occurring in real-time and in real-life.

Referring still to FIG. 7, at step 704, the system creates a tabletop exercise based on the uploaded incident response plan. At step 706, stakeholders are invited to participate in the tabletop exercise via the exemplary platform. In some embodiments, the facilitator will invite stakeholders, or otherwise furnish the names and contact information of the stakeholders to the exemplary platform, so that the platform can transmit the invitations to the stakeholders accordingly. In other embodiments, the system, using machine learning and possibly with access to the entity's databases, can determine which stakeholders should be invited to participate in the tabletop exercise and proceed to do so without the assistance of the facilitator.

If an invited stakeholder accepts the invitation furnished by the platform, they become a participant of the tabletop exercise. The participant can log onto the exemplary platform or system. In some embodiments, the platform can be accessed via a mobile application that the participant can download, access, and log onto using their mobile phone or tablet. However, it will be understood by those skilled in the art that the platform can be accessed by any type of computing device associated with the participant, and access to the platform is not limited to merely mobile phones or tablets.

Once the participants have accepted the invitation to participate in the tabletop exercise, at step 708, an “isolate mode” of the exemplary platform is enabled to enhance security measures. The “isolate mode” can be activated by a facilitator. The facilitator may be a human facilitator, or the facilitator may be part of the exemplary platform that has developed a knowledgebase as to when the isolate mode should be activated.

When the isolate mode is activated, the orchestration service and/or the digital collaboration room (as described earlier herein) is isolated from other aspects, tools, corporates pieces, or services belonging to the entity. In some embodiments, the isolated orchestration service and/or the digital collaboration room are components of the platform that is isolated, removed or otherwise severed from the rest of the entity's ecosystem of corporate tools and services.

In other embodiments, activating an isolate mode and isolating the digital collaboration room further comprises severing any and all integrations on multiple levels with the digital collaboration room (such as the integrations of the digital collaboration room with any other portion of the entity's ecosystem), and blocking any further attempts of integrating the entity's ecosystem with the digital collaboration room. Further information about the isolate mode is provided in related application U.S. application Ser. No. 18/196,967, filed on May 12, 2023, titled “Systems and Methods for Providing Secure Access to Collaboration Rooms with Dynamic Tenancy in Response to an Event”, which is incorporated by reference in its entirety as if fully set forth herein.

In some embodiments, once an event or an incident occurs, because the isolate mode has been activated (that is, the isolate mode is “on”), the participant or user is not automatically blocked. Instead, the user is notified that they can no longer use their corporate email to login to access the entity and the entity's corporate tools and the user is rerouted to another pathway. In other words, the orchestration service will try to actively handle the user experience of being rerouted to another pathway.

Referring still to FIG. 7, at step 710, the exemplary platform runs through the tabletop exercise or otherwise facilitates the tabletop exercise to be presented to the participants, typically under the guidance of the facilitator. The exemplary platform allows the participants to collaborate on the incident response plan during the tabletop exercise. In some embodiments the simulation of the tabletop exercise allows for participants to practice as a team on working through the incident response plan, and in doing so, the participants and/or the facilitator may identify improvements or changes that should be made to the incident response plan. The participants and/or the facilitator may discuss such improvements or changes to the incident response plan, or they may discuss aspects of the tabletop exercise, using a chat program or a secure conferencing capability of the exemplary platform.

In some embodiments, during the tabletop exercise, via the platform, the facilitator unveils or unlocks one or more injects to present simulations of run time scenarios to the participants, in order to measure the effectiveness of incident response plan and preparedness of the incident response team (that is, the participants of the tabletop exercise). An inject is defined as a simulation of a runtime scenario. In some embodiments, upon the completion of a first inject by the participants, the facilitator can unveil or unlock a second inject for the participants to view and respond to the scenario presented. Further examples of injects will be provided later herein.

Once the tabletop exercise has concluded, an after action report (AAR) is generated by the exemplary platform at step 712. The after action report is later distributed by the exemplary platform to the facilitator and the participants of the tabletop exercise, to provide meaningful insight, tips, and lessons about the tabletop exercise and the incident response plan that were utilized during the tabletop exercise. At step 714, the incident response plan (which was originally uploaded by the facilitator or the entity) is refined, based on the inputs that the system captures as part of the tabletop exercises and the outcomes of the tabletop exercise. In some embodiments, the refining of the incident response plan includes feedback provided by the system, which will be described in greater detail later herein.

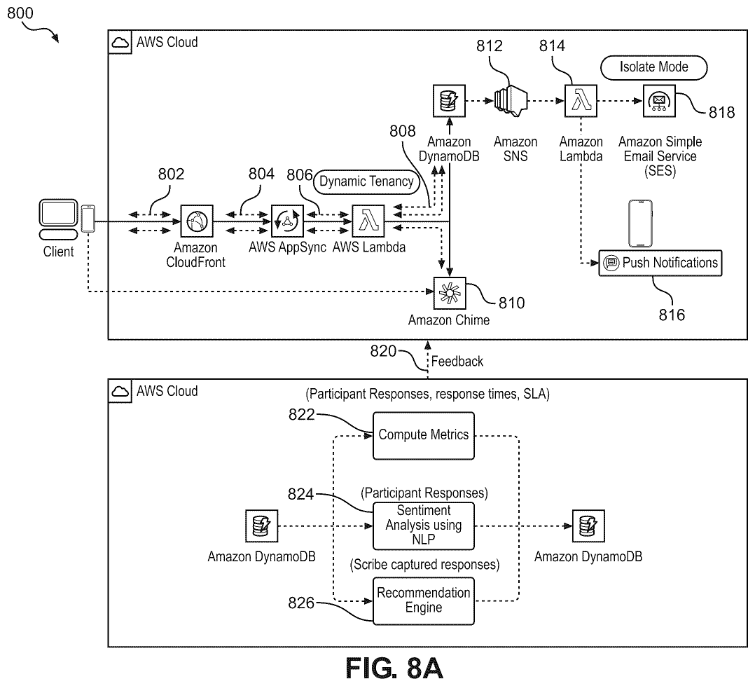

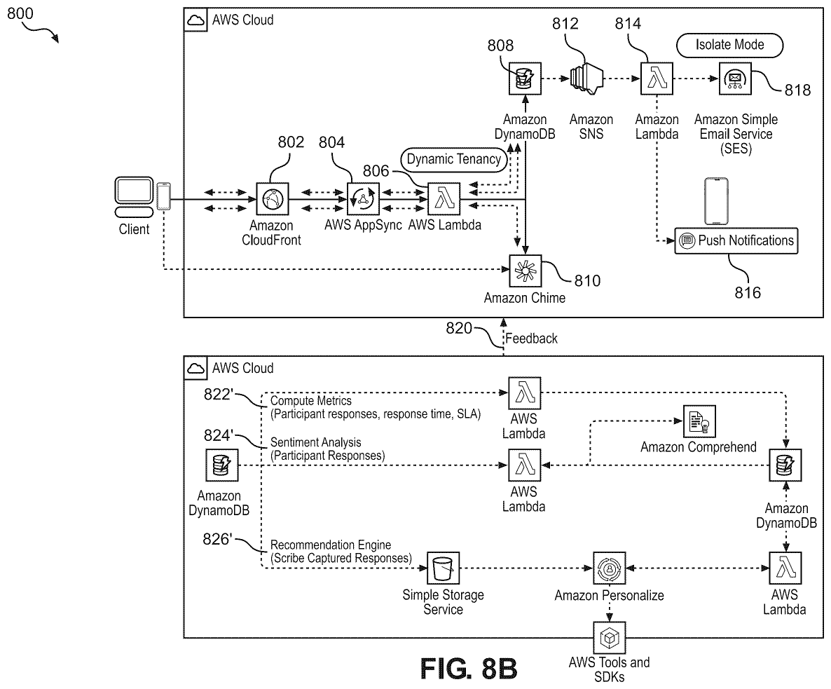

FIGS. 8A and 8B are flowcharts of example methods of the present disclosure related to facilitating tabletop exercises and providing feedback. FIG. 8A depicts a method 800 for facilitating tabletop exercises utilizing the exemplary single platform. The client (which may be the client computing device associated with the entity or a facilitator user) uploads an incident response plan onto the exemplary platform and transmits a request to the exemplary platform, requesting the platform to generate a tabletop exercise based on the incident response plan.

In response to the uploading of the incident response plan by the client, the exemplary platform captures the type of the incident response plan, and the exemplary platform also captures certain metadata. At steps 802, 804, and 806, the request from the client is transmitted to a content delivery network (such as Amazon Cloudfront), and then to a managed GraphQL service (such AWS AppSync) which has endpoints that are further supported by a serverless compute service (such as AWS Lambda) within the platform. The serverless compute service is where the business logic of the platform resides.

At step 808, the platform generates a tabletop exercise and stores a record of the tabletop exercise in a database associated with the platform, such as Amazon DynamoDB. Similar to the client's total control and access of an incident response room (also known as a collaboration room) as described earlier herein, the client has total control and access of the tabletop exercise using the concept of dynamic tenancy. That is, the client is the owner of the data of the tabletop exercise. Vendors and third parties do not own the data of the tabletop exercise. Instead, the client invites vendors and third parties to participate in the tabletop exercise using the same dynamic tenancy model as the collaboration room as described earlier herein.

During a tabletop exercise, the facilitator can lock or unlock one or more injects. An inject is a simulation of a runtime scenario that is used during a tabletop exercise. Initially, the facilitator creates a pipeline of injects with the platform's assistance. When an inject is in the locked state, none of the participants can view the inject; that is, only the facilitator can view the locked inject. As the tabletop exercises progresses, the facilitator can unveil or unlock one or more injects for the participants to access. When an inject is in the unlocked state, the participants can also view the details of the inject. The inject presents a new scenario for the participants to review and analyze.

During the tabletop exercise, the facilitator can ask the participants questions associated with the inject, such as what is the next step to be taken to address the incident at hand. At this point, the participants have the ability to respond to the facilitator's questions, the participants can work as a team in a brainstorming exercise to assess the scenario presented in the inject, and during the tabletop exercise, the participants also have the ability to invite more people (such as other third parties or vendors) to the collaboration room. Once the inject is resolved, then the facilitator can unlock the next inject. The unlocking of the next inject can be done by the human facilitator, or by the system itself due to the system's machine learning to dynamically unlock the next inject or generate and introduce a new inject during the tabletop exercise.

At step 810, in some embodiments, the participants are invited to the tabletop exercise by the exemplary platform and can join the conference call via a secure communications service. The conferencing facility of the exemplary platform is implemented using the secure communications service (such as Amazon Chime), so that participants on the exemplary platform can converse with each other and with the facilitator about the tabletop exercises and the one or more injects that are unlocked and accessible to the participants. Also, participants can provide responses to the injects or to the questions posed by the facilitator via the exemplary platform. Those responses are captured and analyzed by the exemplary platform, to later create the after action report that will be distributed to the participants and facilitator. Also, those responses can be utilized by one or more machine learning models of the exemplary platform which will be described below, in order to provide feedback to the exemplary platform and refine the incident response plan.

At steps 812-818, a notification flow of the method 800 occurs. Specifically, with the help of a managed messaging service for communication (such as Amazon SNS), a serverless compute service (such as AWS Lambda) where the business logic of the platform resides, and an email service (such as Amazon Simple Email Service), in order to simulate a real-life incident or crisis scenario, the facilitator can activate or turn on “isolate mode” for that particular tenant where the tabletop exercise is being carried out. When the “isolate mode” is turned on, all the emails are routed to the backup emails of the participants and not to the organization/entity email. That is, at steps 816 and 818, with the “isolate mode” activated, push notifications and email communications are sent to the backup emails of the participants. This re-routing of push notifications and emails allows for the participants to practice the incident response plan, as if they are responding to a real-life, dynamic incident, such as an active cyber crisis during which the organization/entity email server has been compromised and is therefore inaccessible to the participants.

At step 820, the system generates feedback. The system's feedback can be incorporated by the platform to refine or otherwise improve the incident response plan and/or the tabletop exercise for future use. The system has three engines or models for generating feedback, namely, the compute metrics model, the sentiment analysis model, and the recommendation model. In some embodiments, one or more of the compute metrics model, the sentiment analysis model, and the recommendation model comprise a machine learning model.

At step 822, using the compute metrics model and by measuring participants' responses, participants' response times, and service level agreement (SLA) response times, the system can determine four attributes. First, the system can determine the mean response time which measures how much time elapsed for a participant to respond to a particular inject during the tabletop exercise. The system can measure the responses made by the participant during the tabletop exercise. The system can capture the participant's response time, since the system has an activity log. That is, the system can log when the participant starts an inject (start time) and when the participant ends the inject (end time). The difference between the start time and end time measures the participant's response time. In other words, the participant's response time can be measured by measuring the time between injects.

Second, with the compute metrics model, the system can also capture any variation between actual response time versus SLA response time (stipulated or guaranteed time to respond to an incident, as provided by the service level agreement (SLA)). In other words, the system determines whether the participant or the team of participants that engaged in the tabletop exercise can respond to an incident within the stipulated SLA response time, and whether the participant(s) need more time beyond the stipulated SLA response time.

Third, using the compute metrics model, the system can measure a participant engagement quotient. From the total number of participants of the tabletop exercise, the system can determine how many participants actually participated by responding to an inject. This type of information provides valuable feedback to the facilitator to determine which people need to be engaged by the facilitator, in order to ensure the success of the tabletop exercise.

Finally, using the compute metrics engine, the engine can determine the preparedness quotient. By measuring the preparedness quotient, the system can answer whether all the levels of service have been defined by the service level agreement and met by the team of participants, how prepared is the team of participants to respond to an incident, and what needs to be done in order to ensure that the participants are prepared to respond to an incident.

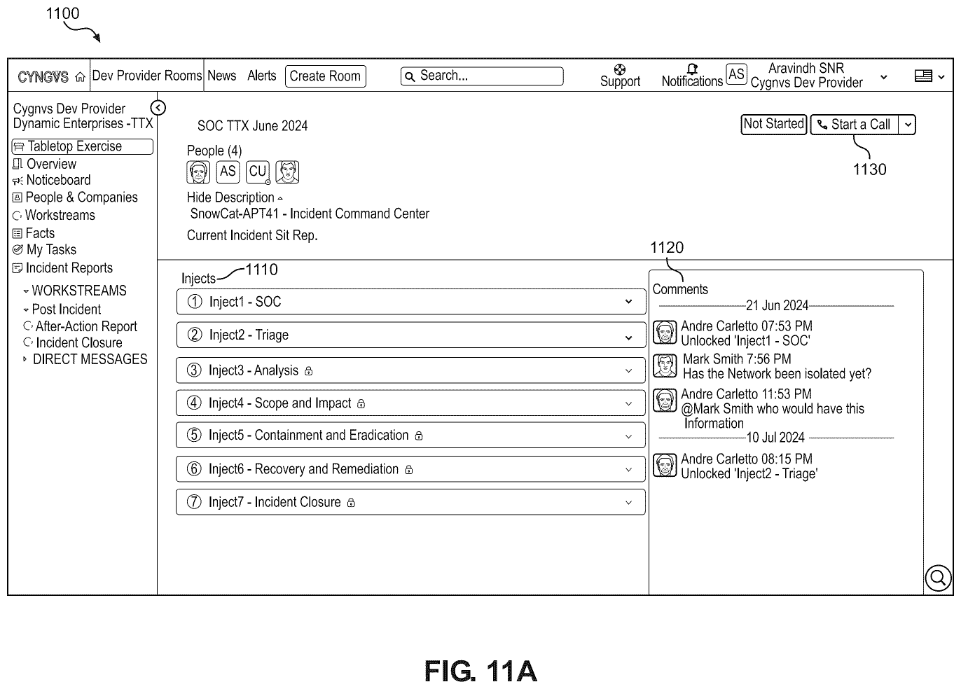

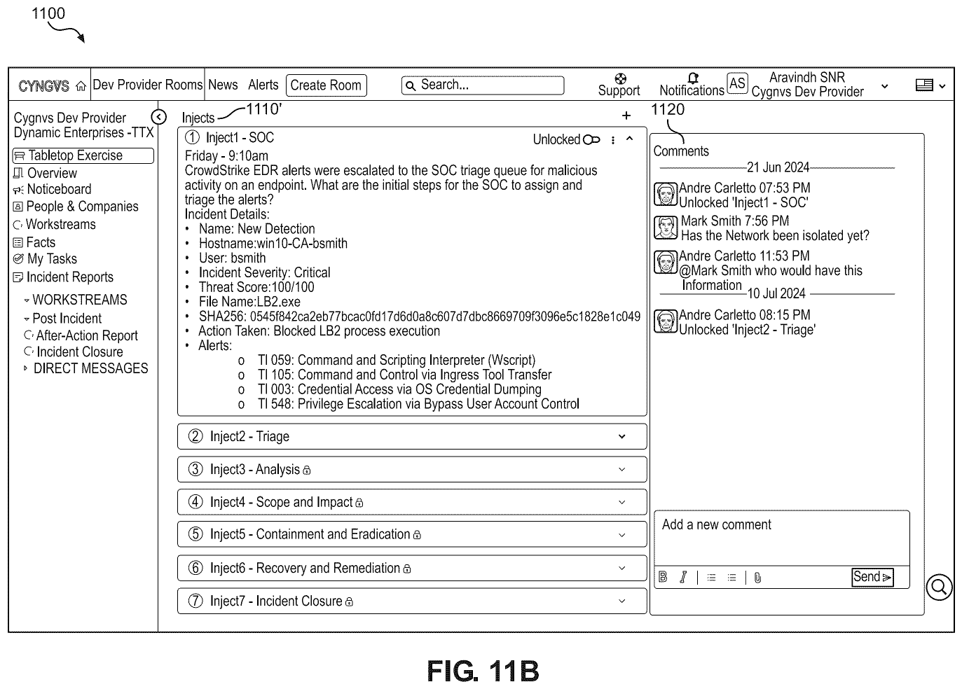

At step 824, a sentiment analysis model processes participants' responses in order for the system to generate feedback. The sentiment analysis engine uses natural language processing (NLP) to analyze a participant's comments and responses that the participant made during the tabletop exercise. Those comments and responses can be provided by the participant, via text (by way of a comment box 1120 as depicted in FIGS. 11A and 11B) or via the secure communications channel (such as the participant's words made during a conference call using a conference feature 1130 depicted in FIG. 11A). The system captures the participant's comments and responses made during the tabletop exercise. Later, the system can determine whether the sentiment of the participant's comments is positive, negative, mixed or neutral. Also, the sentiment analysis engine can determine whether a participant perceived that the tabletop exercise is easy or difficult.

The sentiment analysis engine can also determine entity recognition, which means that the system can understand the context of a participant's comment. The system can determine if the participant's comment is about an entity such as an inject, a work stream, or a incident, and the system can also relate a sentiment to the particular entity.

Further, the sentiment analysis engine can make a determination of effort levels. The sentiment can be one relating to complexity and frustration. For instance, frustration can arise when the incident response plan does not have the necessary steps outlined to provide a participant with the necessary knowledge to implement a robust response to an incident. If the incident response plan has missing steps, particularly if the incident response plan has some complexity, this in turn may cause uncertainty on the part of a participant, since the participant will believe they are unable to appropriately respond to an incident. The determination that the sentiment is frustration can mean that the incident response plan needs to be refined or that the incident response plan needs to be amended to include the missing steps.

At step 824, a third model called the recommendation engine or recommendation model processes a scribe's captured responses for the system to generate feedback. A scribe can be human or can be a computing machine, and the scribe's role is to take notes during tabletop exercises. The system has an activity log of every event that has happened and who did what action during the tabletop exercise. Using these data points, the system can determine what next steps are needed when a real-life incident occurs. In other words, the recommendation model can identify gaps in the incident response plan and provide recommendations. Thus, a participant's actions during a tabletop exercise can be used as a training data set for the recommendation engine. Using this training data set, the system can make recommendations during a real-life incident, or the system can validate the recommendations using the current incident response plan, to see whether all the recommended actions are already listed as part of the incident response plan. If at least one of the recommended actions recommended by the recommendation engine is missing from the incident response plan, then the missing recommendation actions are added to the incident response plan so that the next time a tabletop exercise is conducted, it will be easier for participants to proceed with the recommended actions as set forth in the updated incident response plan.

It should be noted that in some embodiments, the recommendation model or engine will analyze the entire universe of captured responses of the scribe. In other embodiments, the recommendation engine will analyze the captured responses of the scribe for a single client. Also, it is noteworthy that the present disclosure encompasses embodiments where the scribe and/or the recommendations are automated features of the system itself.

FIG. 8B depicts a method 800 for facilitating tabletop exercises utilizing the exemplary single platform. FIG. 8B is very similar to FIG. 8A. However, in FIG. 8B, the exemplary implementations of the compute metrics model, the sentiment analysis model, and the recommendation model are depicted. At step 822′, the determination and measurement of certain metrics using participant responses, response times, and SLA response times by the compute metrics ML model can be implemented using the AWS Lambda and then stored in a database such as AmazonDynamoDB. At step 824′, the determination of sentiment based on a participant's responses during a tabletop exercise can be accomplished by leveraging AWS Lambda and Amazon Comprehend. Amazon Comprehend can aid in entity recognition and sentiment analysis. Amazon Comprehend can determine the entity based on the sentence of the response used. At step 826′, the recommendation engine generates recommendations by leveraging a machine learning (ML) service, such as Amazon Personalize. Based on a machine learning model, the recommendation engine can make recommendations of what are the next best actions to respond to an incident. The recommendation engine can then provide those recommendations in a ranked fashion. The recommendations can be based on personas. A persona is a combination of an incident type, department, and role, all of which are actual entities already determined by the system.

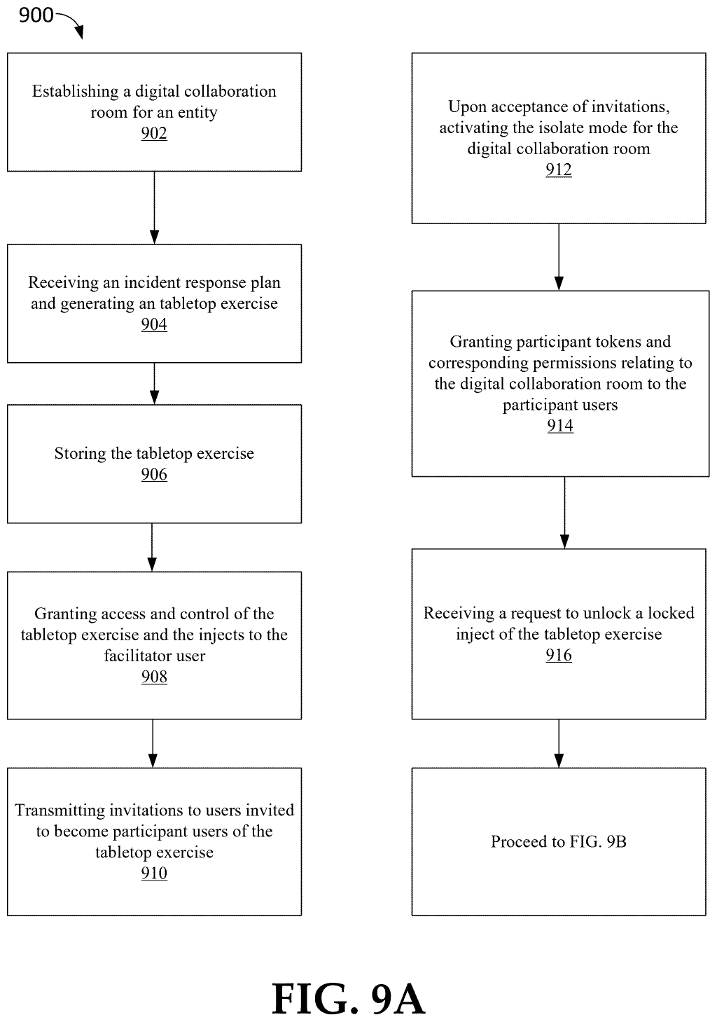

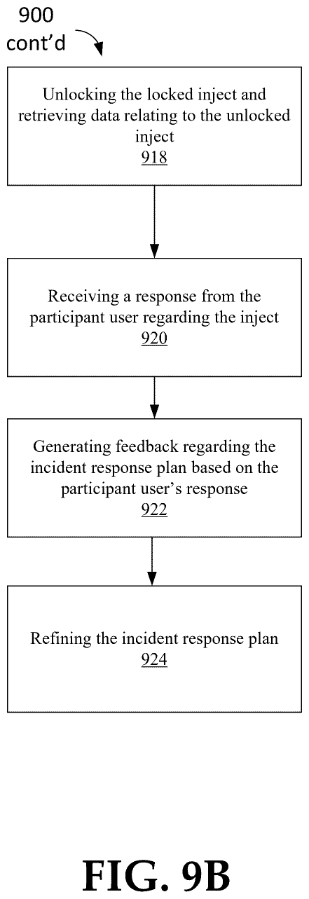

FIGS. 9A and 9B depict a flowchart of an example method related to facilitating tabletop exercises using collaboration rooms with dynamic tenancy. At step 902, a digital collaboration room (also known as an incident room) is established for an entity, via an orchestration service, as earlier described above. The entity has control to grant permissions to users regarding the digital collaboration room and to dynamically modify permissions of the users in real time. The orchestration service may comprise a cloud resource where the digital collaboration room, owned by the entity, is hosted and made accessible to the users. Entities can issue tokens to users in order for the users to access the plurality of digital collaboration rooms. Each user may be issued one of the tokens and each of the tokens comprises a tenant identifier that identifies one of the plurality of entities, a digital collaboration room identifier, and a role with a set of permissions. In some embodiments, the tabletop exercise is executed or run through in the digital collaboration room. As an example, a facilitator user who moderates the tabletop exercise may be granted different permissions relating to the collaboration room in comparison with a participant user of the tabletop exercise.

At step 904, an incident response plan is received. In some embodiments, the incident response plan is received by the entity tenant or by the facilitator user on behalf of the entity tenant. The incident response plan is uploaded onto the exemplary platform. Based on the incident response plan, a tabletop exercise is generated by the exemplary platform. The tabletop exercise has one or more injects. Each inject is a simulation of a runtime scenario, and each inject can be either locked or unlocked. In some embodiments, the inject is locked or unlocked at the command of the facilitator user. At step 906, the tabletop exercise is stored in a database associated with the collaboration room. At step 908, access and control of the tabletop exercise and the injects is granted to the facilitator user, who moderates participant users during an execution or running of the tabletop exercise on the exemplary platform. At step 910, invitations are transmitted to users who are invited to become a participant user of the tabletop exercise. In some embodiments, the facilitator (on behalf of the entity tenant) will invite stakeholders, or otherwise furnish the names and contact information of the stakeholders to the exemplary platform, so that the platform can transmit the invitations to the stakeholders accordingly. Those stakeholders may include external providers or vendors. In other embodiments, the system, using machine learning and with access to the entity's databases, can determine which stakeholders should be invited to participate in the tabletop exercise and proceed to do so without the assistance of the facilitator.

At step 912, upon receiving acceptance of the invitations by the one or more users to become a participant user, an isolate mode for the collaboration room is activated. During the isolate mode, participant users are notified or re-routed to access the collaboration room by way of the participant user's backup email account. That is, participant users are prohibited from accesses the collaboration room using their email account with the entity (which is sometimes referred to as the user's corporate email account).

At step 914, participant tokens and corresponding permissions relating to the collaboration room are granted to the participant user. At step 916, a request from the facilitator user to unlock a locked inject of the tabletop exercise is received. In response to the request, the locked inject is unlocked at step 918, and data relating to the unlocked inject is retrieved from the database for the digital collaboration room. By unlocking the previously locked inject, the system grants the participant user with access to the data relating to the unlocked inject.

At step 920, a response from the participant user is received regarding the data relating to the inject. At step 922, based on the response from the participant user, feedback is generated regarding the incident response plan. The feedback can be obtained from a recommendation machine learning model that is trained to identify gaps in the incident response plan and provide recommendations to improve the incident response plan. At step 924, the incident response plan is refined by the exemplary platform. The refinements are based on the response received from the participant user and the generated feedback.

In some embodiments, following the completion of the tabletop exercise, an after action report is generated and distributed to the facilitator and the participants of the tabletop exercise regarding the tabletop exercise and the incident response plan. The after action report may provide meaningful insight, tips, and lessons about the tabletop exercise and the incident response plan that were utilized during the tabletop exercise.

The tabletop exercise may include a plurality of injects, such as a first inject and a second inject. In some embodiments, upon the completion of a first inject by the participants, the facilitator can unveil or unlock a second inject for the participants to view and respond to the scenario presented. In some embodiments, upon the completion of the first inject by the participant user, the system locks the first inject so that the participant users can no longer access data relating to the first inject, and the system also unlocks the second inject so that the participant users can access data relating the second inject. The locking of the first inject and the unlocking of the second inject can be initiated by a request from the facilitator user or the entity.

The feedback that is generated by the exemplary platform can come from the compute metrics engine, the sentiment analysis engine and/or the recommendation engine, which are depicted in FIGS. 8A and 8B. In some embodiments, the generated feedback regarding the incident response plan includes feedback from a compute metrics engine that is based on measuring a participant user's responses, a participant's response time, and a service level agreement (SLA) response time. Such feedback may include on or more of the following: a determination of a mean response time of the participant user, based on how much time elapsed for the participant user to respond to an inject during the tabletop exercise; a determination of any variation between actual response time versus service level agreement (SLA) response time; a measurement of a participant engagement quotient, based on a number of participant users who provide responses to an inject and a total number of participant users of the tabletop exercise; and a measurement of a preparedness quotient, to determine how prepared the participant user is to respond to an incident.

In some embodiments, the generating of the feedback includes processing a capture, made by a scribe, of the participant user's response during the tabletop exercise. The scribe's role in the tabletop exercise is to take notes or otherwise capture the responses and actions of the participant user that are made during the tabletop exercise. The captured participant user's responses can be used as a training data set for the recommendation machine learning model. Once the recommendation machine learning model is trained, it can provide new recommendations, and it can validate its previous or current recommendations regarding the incident response plan.

In other embodiments, the generated feedback is obtained from a sentiment analysis model, which is configured to process a participant user's responses by using natural language processing (NLP) to analyze the participant's responses made during the tabletop exercise. The sentiment analysis model can also be further configured to determine entity recognition and relate a sentiment to the entity. The sentiment analysis model may also be further configured to determine effort levels.

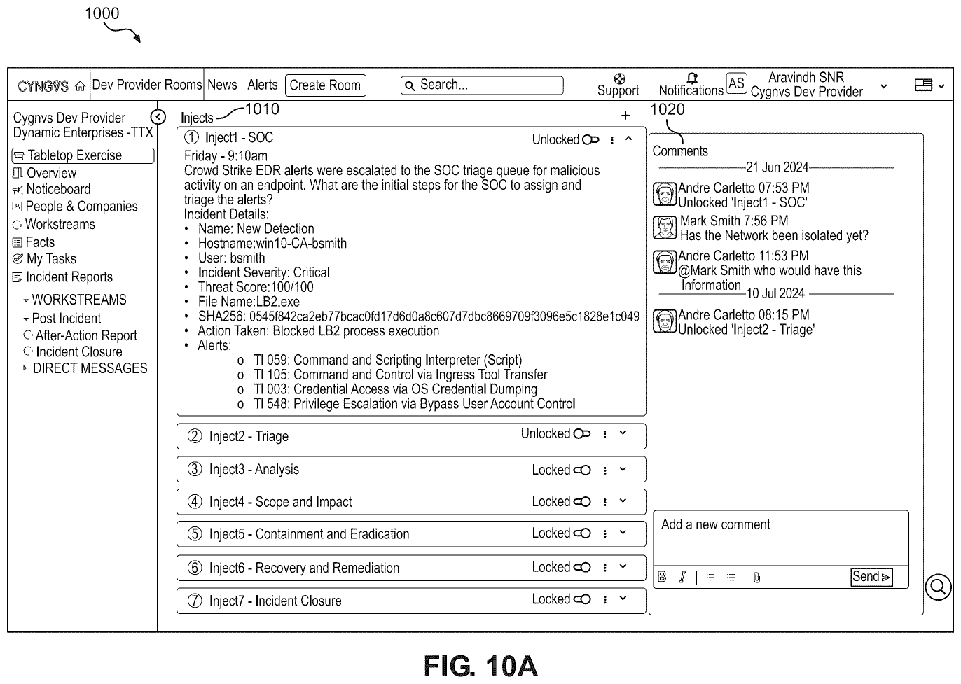

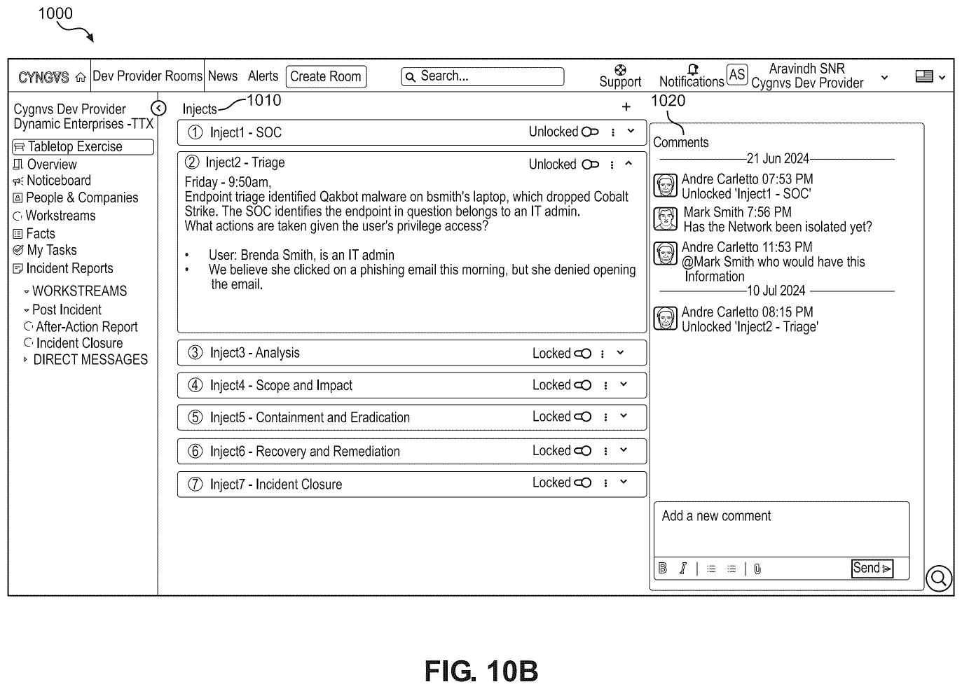

FIGS. 10A and 10B are exemplary screenshots of a facilitator's dashboard user interface during a tabletop exercise. FIG. 10A shows a dashboard 1000 of a facilitator using the exemplary platform upon the initiation of a tabletop exercise. The dashboard 1000 displays one or more injects 1010 from the view of the facilitator. The one or more injects 1010 will be shown to participants of the tabletop exercise during the running of the tabletop exercise. Specifically, the dashboard 1000 in the example provided by FIG. 10A depicts a first inject entitled “Inject 1-SOC” which the facilitator has unlocked or otherwise unveiled to the participants during the tabletop exercise, so that the participants can access, view and respond to the details presented in the first inject. It should be noted that by adding comments in a comment box 1020, participants and the facilitator can communicate with one another during the tabletop exercise. In the example provided in FIG. 10A, the exemplary comment box 1020 shows that a facilitator (named Andre Carletto) has commanded the exemplary platform to unlock “Inject 1-SOC” and has also asked a question to a participant (named Mark Smith) about the first inject. Furthermore, the participants' responses and the facilitator's comments made in the comment box 1020 can be utilized by one or more of the compute metrics engine, the sentiment analysis engine, and the recommendations engine, as datasets for providing feedback back to the platform.

FIG. 10B also shows an example dashboard 1000 of a facilitator using the exemplary platform upon the unlocking of a second inject of a tabletop exercise. The dashboard 1000 displays one or more injects 1010 from the view of the facilitator. The one or more injects 1010 will be shown to participants of the tabletop exercise during the running of the tabletop exercise. Specifically, the dashboard 1000 in the example provided by FIG. 10B depicts a second inject entitled “Inject 2-Triage” which the facilitator has unlocked or otherwise unveiled to the participants after the first inject (depicted in FIG. 10A) has been completed during the tabletop exercise, such that the participants can now view the details presented in the unlocked second inject. Like FIG. 10A, FIG. 10B also displays the other injects (Injects 3 through 7) listed below the second inject. By adding comments in a comment box 1020, participants and the facilitator can communicate with one another during the tabletop exercise. As shown in the last comment of the exemplary comment box 1020 presented in FIG. 10B, a facilitator (named Andre Carletto) has commanded the exemplary platform to unlock “Inject 2-Triage” which caused the platform to display the unlocked details of the second inject to the participants. The participants' responses and the facilitator's comments made in the comment box 1020 can be utilized by one or more of the compute metrics engine, the sentiment analysis engine, and the recommendations engine, as datasets for providing feedback back to the platform.

FIGS. 11A and 11B are exemplary screenshots of a participant's dashboard user interface during a tabletop exercise. FIG. 11A shows a dashboard 1100 of a participant using the exemplary platform upon the initiation of a tabletop exercise. The dashboard 1100 displays one or more injects 1110 from the view of the participant, which are all currently locked at the start of the tabletop exercise and therefore no details of the injects can be viewed by the participant, other than the titles of the injects. These one or more injects 1110 will eventually be unveiled by the facilitator or otherwise shown to the participant of the tabletop exercise during the running of the tabletop exercise. Specifically, the dashboard 1100 in the example provided by FIG. 11A depicts only the title of a first inject (namely, “Inject 1-SOC”) which has not yet been unlocked by the facilitator. It should be noted that by adding comments in a comment box 1120 provided by the exemplary platform, the participants and the facilitator can communicate with one another during the tabletop exercise. Further, the participant's dashboard 1100 include a secure conference call feature 1130 which can be utilized by the participants and the facilitator as a means of communication during the tabletop exercise via the exemplary platform. Again, the participants' responses and the facilitator's comments made in the comment box 1120 or via the conference call feature 1130 can be utilized by one or more of the compute metrics engine, the sentiment analysis engine, and the recommendations engine, as datasets for providing feedback back to the platform.

FIG. 11B also shows an example dashboard 1100 of a participant using the exemplary platform upon the unlocking of a first inject of a tabletop exercise. The dashboard 1100 displays one or more injects 1110′ from the view of the participant. The one or more injects 1110′ may eventually be unveiled by the facilitator or otherwise shown to the participant of the tabletop exercise during the running of the tabletop exercise. Specifically, the dashboard 1100 in the example provided by FIG. 11B depicts only the title and details of the first inject “Inject 1-SOC” which has been unlocked by the facilitator and can be viewed by the participant. However, the dashboard 1100′ also shows that the other injects listed below Inject 1 (namely, Injects 2 through 7) are all still locked and therefore no details of those specific injects can be viewed nor accessed by the participant, other than the titles of the injects. It should be noted that by adding comments in a comment box 1120 provided by the exemplary platform, the participants and the facilitator can communicate with one another during the tabletop exercise. Again, the participants' responses and the facilitator's comments made in the comment box 1120 or via the conference call feature 1130 can be utilized by one or more of the compute metrics engine, the sentiment analysis engine, and the recommendations engine, as datasets for providing feedback back to the platform.

### Continuous Cybersecurity Readiness

Systems and methods for providing continuous (or near-continuous) cybersecurity readiness are described herein. Such systems and methods address many issues that a company or an organization's Chief Information Security Officer (CISO) face. Traditionally, a CISO can plan but cannot prove the readiness of his organization or his team to respond to incidents, crises or unexpected events, such as a cybersecurity incident, a threat, a data breach, a cyberattack, and the like. Using traditional approaches, a CISO encounters a “say-versus-do” gap, since having a playbook of the organization does not guarantee that the CISO's team can execute under pressure, such as when a real-life cybersecurity incident occurs. A playbook is defined as a structured, documented set of procedures, processes, and response actions that an organization follows when responding to specific types of cybersecurity incidents or security events.

Also, a CISO may encounter point-in-time blindness using traditional systems, since annual table exercises provided by traditional systems are infrequent, isolated, and fail to measure day-to-day readiness of a team or an organization. Tabletop exercises capture only a snapshot in time. Currently, there is oftentimes a gap of time from when the tabletop exercise is completed to when the team would receive feedback from a tabletop exercise. Furthermore, current systems do not provide a scalable, data-driven way to quantify a team or an organization's true resilience. Finally, traditionally, CISOs lack a defensible artifact that can answer a board of director's crucial question “Is the organization or team ready to act in the event of a cybersecurity incident or threat?”

To address these critical issues that a CISO faces, the present disclosure describes an exemplary system of continuous cybersecurity readiness. The exemplary system enables security tabletop exercises and training to operate as a continuous, integrated process, rather than as isolated, point-in-time events. The architecture of the exemplary system (which will be described in greater detail later herein) leverages dual artificial intelligence (AI) agents to automate both adversarial scenario generation and response evaluation, thereby supporting ongoing organizational readiness and rapid adaptation to new threats. A tabletop as used herein is defined as a structured, discussion-based training session where teams practice incident response procedures. A scenario is defined as a detailed simulation of a cybersecurity incident or attack that forms the content of a tabletop exercise. Scenarios can be as part of tabletops and drills.

An aspect of the exemplary system is it provides continuous, integrated tabletop and training operations. Unlike traditional tabletop exercises, which are typically scheduled as one-off or periodic events, this system supports continuous, execution of training and assessment scenarios. Drills, simulations and readiness assessments can run asynchronously and persistently, allowing organizations to maintain a living state of preparedness. Readiness assessments are evaluations of an organization's current state of preparedness to detect, respond to, and recover from cybersecurity incidents. Specifically, such evaluations include evaluating people, process, playbooks, technology, frequency and scale of practice, etc.

Another aspect of the exemplary system is that the system includes a dual AI architecture. Specifically, the exemplary system utilizes two AI agents, namely, an adversary AI and a user agent AI. The adversary AI continuously generates and adapts threat scenarios based on real-time intelligence, organizational content, and historical performance. The user agent AI continuously evaluates user and system responses, providing real-time scoring, feedback, and guidance. Each of the adversary AI and the user agent AI can operate autonomously, enabling the exemplary system to function without manual intervention.

A further aspect of the exemplary system is that the system includes automated evaluation, guidance and feedback loops. Specifically, the exemplary system provides automated, expert-level evaluation and guidance, supporting both human-in-the-loop and fully autonomous operation. Also, multi-layered feedback loops between and among AI agents (such as the adversary AI and the user agent AI) and users enable ongoing adaptation and improvements of both scenarios and response strategies.

Yet another aspect of the exemplary system is that the system generates dynamic readiness metrics. Readiness is measured and visualized as a dynamic, continuously updated metric, rather than a static score from a single exercise. Readiness is defined as the current state of an organization's preparedness to detect, respond to, and recover from cybersecurity incidents. Resilience is defined as an organization's ability to adapt, recover, and continue operations during and after cybersecurity incidents.

The exemplary system provides ongoing visibility into organization maturity, response quality, and adaptability.

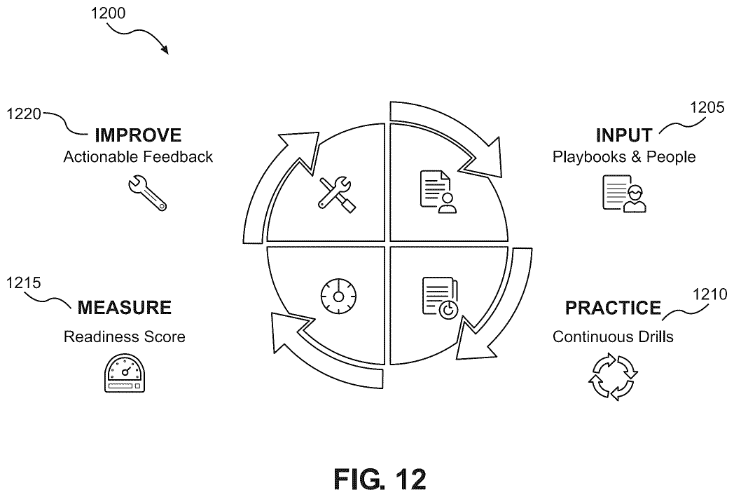

FIG. 12 depicts an exemplary dynamic system 1200 for continuous cybersecurity readiness. The exemplary dynamic system 1200 can be implemented using the systems and methods embodiments described earlier herein, including, for example, the exemplary architecture of FIG. 1 and the computing system of FIG. 6. The system 1200 can include a readiness flywheel, which is a dynamic system for continuous improvement that is driven through the system 1200 platform. The readiness flywheel of the system 1200 transforms the traditional concept of testing readiness from an annual event into a continuous, measurable, and improvable process, creating a living system of resilience.

The system 1200 can include a plurality of phases, including but not limited to, an input phase 1205, a practice phase 1210, a measure phase 1215, and an improve phase 1220. Further details of each phase will be described in greater detail later herein. The system 1200 may go through each of the plurality of phase in a cyclical manner, as depicted in FIG. 12. That is, in some embodiments, the system 1200 may provide a continuous cycle of improvement.

At an input phase 1205, an organization or a team uploads its playbooks to the system. Also, at the input phase 1205, details regarding an organization's people (such as their titles or positions in the organization, their duties, their responsibilities, and the like) are inputted into the system 1200. In other words, the system defines the individuals (users) and the teams that need to be involved and need to be ready for a cyber incident.

At a practice phase 1210, continuous drills are generated by the system 1200 and provided to the team's individuals to complete. Specifically, the system 1200 creates and schedules drills and the testing of the performance of each individual of the team. The system 1200 generates and provides the drill to the individual. The system 1200 may also provide an AI agent to the individual during the drill, so that the individual may interact with the AI agent. The AI agent may help and provide hints or guidance to the individual during the drill. The individual completes the drill through the system 1200 platform.

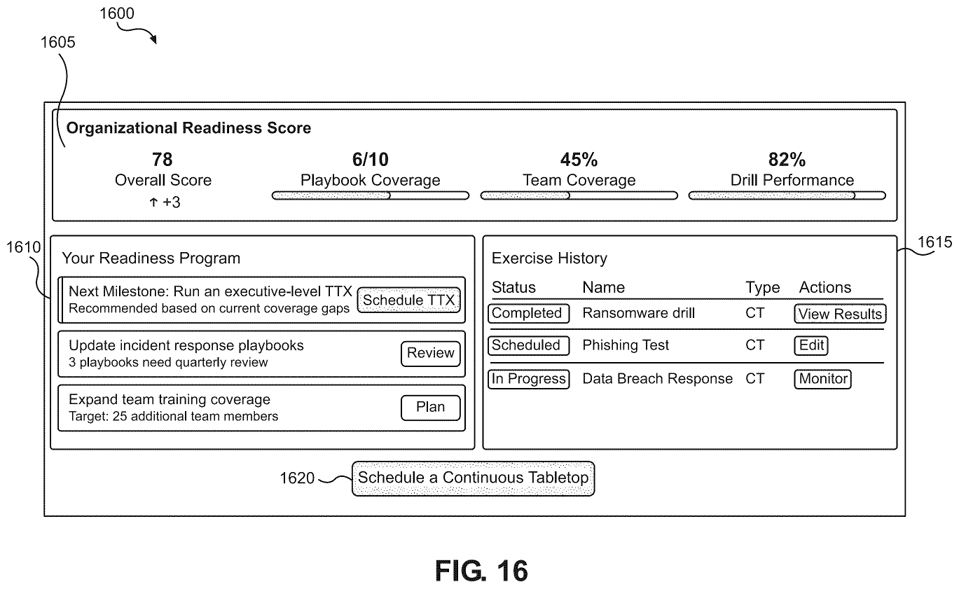

At a measure stage 1215, based on the team's responses to the drill(s) that are generated by the system 1200, a readiness score of the team is measured and provided to the CISO or an administrator of the system 1200. In some embodiments, the readiness score can be an organizational readiness score which can displayed on a CISO's dashboard user interface (see, e.g., organizational readiness score 1605 of FIG. 16). At an improve phase 1220, actional feedback is generated. The actional feedback may include insights about the team or entity. For instance, as part of the actional feedback, the system can determine, as part of the system's measurement of the team's readiness, whether the team members can collaborate and communicate with each other. Also, the system can determine if team members know to whom they need to escalate an incident, if the need to escalate arises.

The actional feedback generated at the improve phase 1220 may be generated or furnished by an artificial intelligence agent. The actional feedback includes feedback for each individual of the team, as well as feedback for the team as a whole. This actional feedback may be provided or displayed to the CISO or administrator of the system 1200. The actional feedback can include a plan for an individual to improve. The actional feedback may also include a plan for the entire team to improve. In some embodiments, the actional feedback may include a plan for sets of teams to improve, particularly if the sets of teams need to work together as a unit. Thus, the exemplary system 1200 generates scores, logs, and reporting tools that are needed by a CISO or administrator of the system 1200 to prove the readiness of the team.

In certain embodiments, the CISO or administrator can correct or provide user input to the system 1200. For instance, if the CISO or administrator desires a different drill, simulation or scenario, they can input parameters that they want measured by the system 1200 as part of the system's evaluation of the team's readiness. Also, if the CISO or administrator wishes to override or modify the actional feedback provided the system 1200 itself or the AI agents, the CISO or administrator can make changes to the actional feedback and provide those changes directly to the system 1200.

After the improve phase 1220, in certain embodiments, the cycle of the flywheel may continue, returning to the input phase 1205. At this point, the actional feedback that was generated at the improve phase 1220 can then be provided as one of the inputs at the input phase 1205. In certain embodiments, the system 1200 can continue the cycle (from the input phase 1205 to the practice phase 1210, from the practice phase 1210 to the measure phase 1215, from the measure phase 1215 to the improve phase 1220, and so forth and so on) using the exemplary methods which will described later herein. One skilled in the art can recognize that the system 1200 can continue cycling through the plurality of phases until an event occurs. As an example, the system 1200 can continue cycling until the CISO or the administrator of the system 1200 inputs a signal or a command for the system 1200 to cease. Another example may be that the system 1200 can continue cycling until a threshold is reached. The threshold may be set by the CISO or the administrator of the system 1200, and the threshold can be time-based (such as a command for the system 1200 to continue cycling for the next 30 days). Further examples of a threshold include a maximum limit per quarter/year. Another threshold can be reached or the frequency of the cycles can be reduced when organization exceeds a readiness score or if improvements in readiness score plateau or meets a readiness score target as set by CISO.

The threshold may be event-based (such as a command for the system 1200 to continue cycle until the team has obtained from the system 1200 a readiness score of 95 or above).

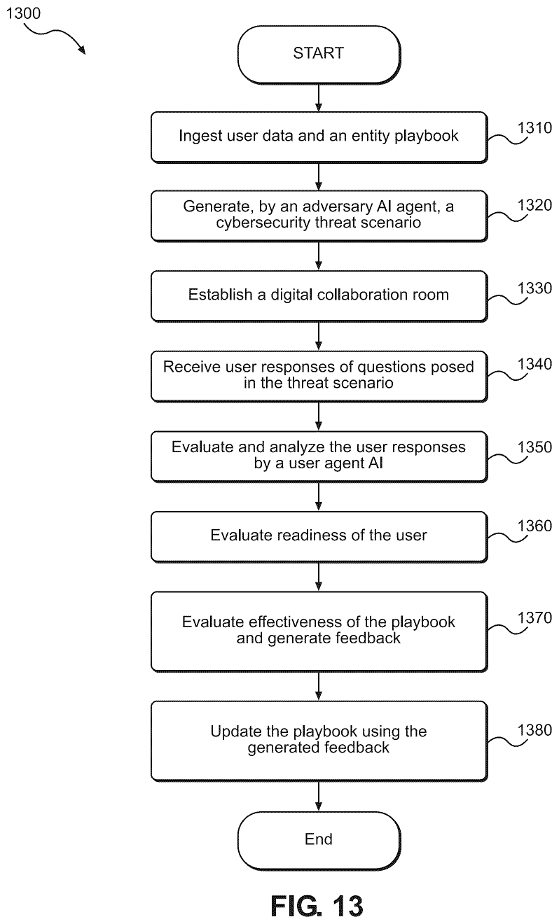

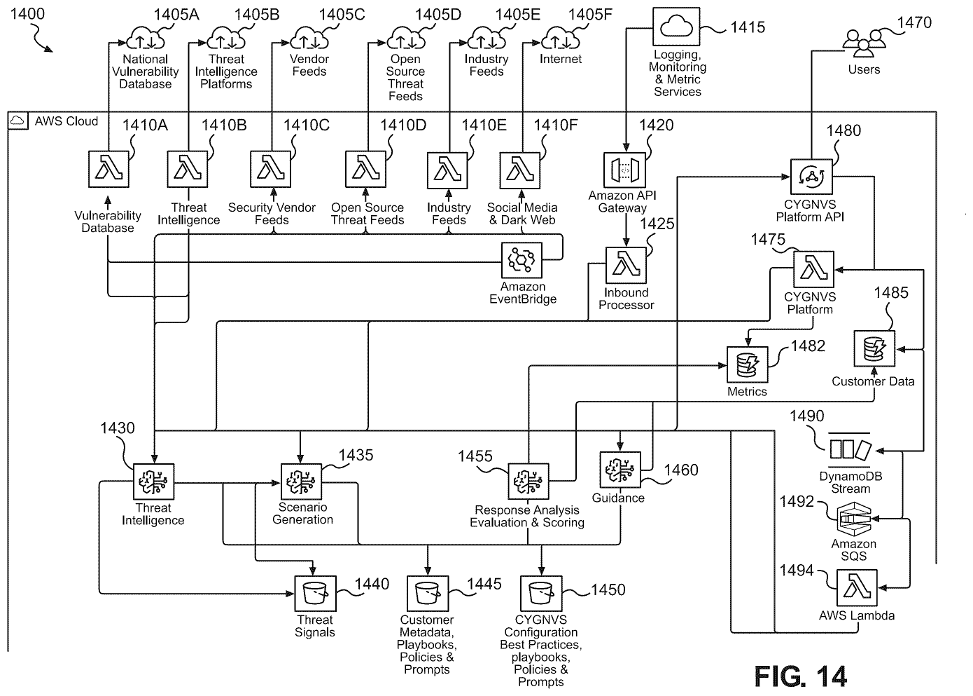

FIG. 13 depicts a flowchart of an example method 1300 for providing continuous cybersecurity readiness, in accordance with an embodiment of the present disclosure. This method 1300 presents a simpler mode for the system, where data regarding users or people and the organization's or entity's playbooks are ingested. A more complex mode for the system will be described later herein in conjunction with FIG. 14.

The method 1300 begins with a step 1310, when user data associated with the user and a playbook associated with the entity are ingested by the system. At step 1320, based on the ingested user data and the playbook, the adversary AI agent generates a cybersecurity threat scenario that is customized for the user. At step 1330, a digital collaboration room for an entity is established via an orchestration service. An exemplary digital collaboration room is shown in FIG. 1. The entity has control to grant permissions to users and artificial intelligence (AI) agents regarding the digital collaboration room. The entity also has the ability to dynamically modify permissions of the users and the AI agents. The orchestration service includes a cloud resource where the digital collaboration room, owned by the entity, is hosted and made accessible to the users and the AI agents. The AI agents may include an adversary AI agent and a user agent AI, both of which will be described in greater detail later herein. At step 1340, the system receives user responses to one or more questions that are posed in the threat scenario. The user typically inputs their responses through the system platform. Alternatively, at step 1340, instead of providing the user with multiple choice answers via the graphical user interface, the system allows for the user to take an action within the collaboration room and the system will update based on the user using the collaboration room as they would in a real-life incident. That is, the user can interact with the collaboration room as they would an incident and then the agent AI can act as the drill facilitator to the user. At step 1350, the user responses are evaluated and analyzed by the user agent AI in real-time. At step 1360, based on the system's AI evaluation and analysis of the user responses, the readiness of the user to respond to a cybersecurity threat is evaluated by the system. Then, at step 1370, the effectiveness of the playbook is evaluated, and feedback is generated about the playbook. The feedback may be generated from one or more feedback loops between the AI agent and the user, between users, and/or between AI agents themselves. Finally, at step 1370, the playbook of the entity is updated by the system. The updating of the playbook can include incorporation of the generated feedback into the playbook.

FIG. 14 is a workflow diagram of an exemplary system 1400 performing a method for providing continuous cybersecurity readiness, in accordance with certain embodiments of the present disclosure. The first stage is called data ingestion and threat processing. During the first stage, the system 1400 conducts external threat data collection. The system 1400 continuously ingests threat intelligence from a plurality of external sources 14050A-1405F through dedicated serverless compute functions 1410A-1410F. In the example provided in FIG. 14, the external sources shown are six in total (namely, a national vulnerability database 1405A, threat intelligence platforms 1405B, vendor feeds 1405C, open source threat feeds 1405D, industry feeds 1405E, and the Internet 1405F), but one skilled in art can recognize that any number of external sources can be used by the exemplary system 1400 for threat data collection.

In some embodiments, the first stage also includes customer (entity) system data processing. During this processing, logging, monitoring and metric services 1415 are provided via an API gateway 1420 to an inbound processor function 1425. The inbound processor function 1425 handles data from a customer system, such as SIEMs, logs, and alerts, performing initial parsing, validation, and normalization. Specifically, SIEM data ingestion and correlation, log parsing and event normalization, customer-specific data enrichment and context addition, and integration with customer metadata and organizational content occur here.

The first stage also includes threat intelligence analysis. As part of this analysis, the adversary AI analyzes processed threat data from the plurality of external sources 1405A-1405F, to identify patterns, trends, and actionable threat intelligence 1430. For initial training data, the adversary AI is initially trained on comprehensive datasets including historical cyber incidents, MITRE ATT&CK framework, NIST threat intelligence reports, security vendor feeds, industry-specific attack patterns, and anonymized incident response playbooks from multiple organizations. For model inputs, the adversary AI receives real-time inputs including external threat feeds, customer SIEM data, organizational metadata, current playbooks, historical performance metrics, and emerging threat intelligence.

Specifically, the adversary AI conducts pattern recognition across multiple threat sources, performs correlation of threats with organizational context, and it identifies emerging attack vectors. For pattern Recognition across multiple threat sources, the adversary AI perform different types of analysis. For instance, for multi-source analysis, the AI analyzes threat data from vulnerability databases, threat feeds, and security reports using machine learning algorithms to identify common patterns and attack techniques. For temporal pattern analysis, the AI tracks threat evolution over time to detect emerging trends and seasonal attack patterns.

For correlation of threats with organizational context, the AI can perform a number of functionalities. For instance, for asset-vulnerability mapping, the AI maps external threats to internal organizational assets, identifying which threats are most relevant based on the organization's technology stack and infrastructure. For risk-based prioritization, the system correlates threat severity with organizational exposure, prioritizing threats that pose the highest risk based on asset criticality and vulnerability status. For industry context integration, the AI considers organizational industry, size, and geographic location to tailor threat relevance and scenario generation.

Furthermore, for model outputs, the adversary AI generates complete cybersecurity incident scenarios including initial attack vectors, progression through organizational systems, specific targets and assets, realistic timeline of events, threat actor motivations and capabilities, technical attack details, and potential escalation paths.

The adversary AI has several scenario generation modes and capabilities. For instance, as a comprehensive mode, the adversary AI has scenario creation using threat signals, customer metadata, and playbooks with full external threat intelligence integration. In a simple Mode, the adversary AI operates without external data, focusing solely on organizational people and playbooks for basic training scenarios. The adversary AI has some customization features, such that it can generate scenarios that are customized based on organizational profile, historical incidents, and team composition.

For expert Content Integration, it incorporates the CYGNVS expert content and industry best practices. For validation and compliance, the adversary AI includes a scenario validation against security policies and compliance requirements. Finally, for distribution and execution, the adversary AI's generated scenarios are distributed to appropriate teams and systems for execution.

The threat intelligence 1430 is utilized to build a knowledgebase of threat signals 1440. The threat intelligence analysis produced by the adversary AI is also incorporated in customer metadata, playbooks, policies and prompts 1445.

The first stage also includes scenario generation. Based on threat intelligence analysis, the adversary AI generates realistic, context-aware threat scenarios. The system will consider the people and playbooks in the organization, and these can also be targeted by the operator. As described in greater detail in conjunction with FIG. 13, the system can also be run in a simple mode, without considering external data and only focused on the people and playbooks.

Still referring to FIG. 14, scenario creation by the AI can utilize and enrich threat signals 1440 and customer metadata, playbooks, policies and prompts 1445. Furthermore, scenario customization may be based on organizational profile and historical incidents. One example is an industry-based customization. For a financial services organization, the adversary AI generates scenarios involving banking trojans, credential harvesting attacks, and regulatory compliance incidents. For a healthcare organization, the AI focuses on scenarios involving patient data breaches, medical device vulnerabilities, and HIPAA compliance violations.

The adversary AI also provides historical incident learning. If an organization previously experienced a ransomware attack through phishing emails, the Adversary AI generates scenarios with similar attack vectors but different payloads, enabling teams to practice improved detection and response procedures.

The AI also includes organizational profile adaptation. For organizations with remote workforces, the AI generates scenarios involving cloud service attacks, VPN vulnerabilities, and mobile device compromises. For organizations with industrial control systems, the AI focuses on scenarios involving OT network attacks and SCADA system vulnerabilities.

The AI integrates the system's configuration, expert content, best practices, playbooks, policies and prompts 1450 of the system platform 1400. Also, scenarios are validated against security policies and compliance requirements. AI-generated scenarios are distributed to appropriate teams and systems for execution, and they can be triggered manually, automatically, or on schedule. There is also support for a continuous AI adversary mode with real-time adaptation, which will be described later herein.

Now turning to the second stage, the second stage is user engagement. As part of user engagement, users 1470 can interact with the system 1400 via the platform API 1480, such that users 1470 can receive scenarios and provide responses to questions posed during a scenario. Users 1470 can interact via Web interface, mobile app, or API client access. A database 1492, a message queuing service 1492, and a compute function 1494 can be utilized in the process of user interactions with the platform 1475 of the system 1400. Also, the users 1470 can be provided with real-time scenario presentation. A user's responses are collected and validated by the system 1400 at this juncture.

User engagement also includes response analysis, evaluation and scoring 1455. The user agent AI of the system 1400 analyzes user responses in real-time, and also evaluates user responses and playbook effectiveness. For the initial training data, the User Agent AI is initially trained on comprehensive datasets including NIST Cybersecurity Framework guidelines, MITRE ATT&CK framework and defense methodologies, incident response playbooks, security best practices documentation, incident response case studies. The training data also includes expert security analyst decision-making patterns, response time benchmarks, from historical security incidents.

The user agent AI conducts user response quality assessment using expert criteria. The user agent AI receives real-time inputs which are user responses or potentially AI responses to scenarios. For response quality assessment, the user agent AI employs natural language processing algorithms to analyze user responses for technical accuracy, completeness, and adherence to established procedures. The AI uses semantic similarity scoring to compare user responses against expert criteria derived from NIST guidelines, MITRE frameworks, and industry best practices. The performance scoring is based on the system's data and customer expert data 1485. The performance scoring system uses weighted scoring algorithms. The user agent AI can identify gaps in knowledge or procedures, and it can provide real-time feedback generation. Specifically, the user agent AI generates feedback on user responses, identification of knowledge gaps and procedural weaknesses, recommendations for improved response strategies, scoring of team performance across multiple dimensions (response time, decision quality, coordination effectiveness), and suggestions for playbook improvements.

The third stage is guidance and feedback generation. For real-time guidance 1460 generation, the user agent AI generates contextual guidance 1460 and recommendations based on evaluation results. The user agent AI can provide immediate feedback for ongoing scenarios. It can also generate actionable recommendations for improvement. The user agent AI can also provide best practice suggestions and reference materials, and it can generate escalation guidance for critical situations. The real-time feedback generation system employs natural language generation algorithms to create contextual, actionable feedback based on real-time assessment results. The AI generates feedback using templates derived from expert security analyst communication patterns and adapts the feedback style and detail level based on user experience and organizational context. The feedback system includes immediate corrective guidance, strategic recommendations, and links to relevant training materials and best practices.

The system 1400 may also perform in an AI commander mode, which is an advanced mode where the AI actively manages exercise and team coordination. In this mode, the AI performs dynamic task assignment and follow-up action, provides real-time team coordination and communication, conducts automated decision-making for routine tasks, and allows for a human-in-the-loop oversight for critical decisions.

The fourth stage is readiness and resilience assessment and reporting. In this stage, dynamic readiness and resilience metrics 1482 are obtained from a continuous calculation and visualization of organizational security readiness and resilience by the system 1400. The metrics 1482 include real-time readiness scores and trends, maturity level assessment and progression, a comparative analysis with industry benchmarks, and predictive analytics for future readiness. Also in the fourth stage, executive reporting and insights can be performed.

Specifically, executive-level reports and insights for strategic decision-making can be generated. This includes board-level readiness summaries, risk assessment and mitigation recommendations, compliance and regulatory reporting, and metrics 1482 that are derived from both AI and non-AI sources.

In certain embodiments, the systems described herein can collect performance data. Specifically, the systems can perform comprehensive data collection from all system interactions for analysis and improvement. This performance data includes response times and decision quality metrics, team coordination effectiveness, scenario difficulty and relevance assessment, and user engagement and satisfaction metrics.

Furthermore, the systems described herein can include multi-layered feedback loops which enable continuous system improvement and adaptation. These feedback loops include one or more of the following:
AI-to-User Feedback: Real-time guidance and recommendations
AI-to-AI Feedback: Adversary AI learns from User Agent AI evaluation results
User-to-AI Feedback: User actions inform future scenario generation
As a first example of AI-to-User Feedback, the scenario provided can be that of a cross-functional team coordination during a data breach response. As part of the AI-to-User Feedback, the AI provides coordination guidance. Such guidance can include statements such as “Legal team needs to be notified within 72 hours for regulatory compliance”, “Communications team should prepare external notification templates” or “Coordinate with HR for potential insider threat investigation”

As a second example of AI-to-User Feedback, the scenario provided can be for responding to user input. As part of the AI-to-User Feedback, the AI can introduce additional challenges. The AI can indicate to the user that “New threat intelligence indicates the attacker has now moved laterally into system X”.

As a third example of AI-to-User Feedback, the scenario provided can be of a team making decisions. As part of the AI-to-User Feedback, the AI provides coordination guidance. Such guidance may include AI statements or guidance to the user of “This decision requires executive approval per company policy”, “Consider GDPR implications before proceeding with data recovery” or “This action may require regulatory notification within 24 hours”.

Now turning to AI-to-AI feedback, in one example, the initial Scenario is where an adversary AI creates a generic malware scenario. The user Agent AI may observe that the team's response doesn't consider their specific industry regulations or compliance requirements. As AI-to-AI Feedback, the user agent AI informs the adversary AI that scenarios need more industry-specific context. As a result, the adversary AI incorporates industry-specific compliance requirements, regulatory frameworks, and business context into future AI-generated scenarios.

In a second example of AI-to-AI feedback, the CISO uploads ransomware response playbook and configures AI personas based on organizational roles (SOC Analyst, Security Manager, IT Admin, Legal, Executive). Each AI persona has different characteristics of skill levels, decision-making speed, focus areas, etc. For automated testing process, in Phase 1: scenario generation, the adversary AI generates sophisticated ransomware scenario. The AI personas execute playbook procedures based on their configured characteristics, and the adversary AI adjusts scenario complexity, attack vectors, or timeline based on ai response inputs. The user agent AI monitors adherence to procedures and decision quality. The user agent AI evaluates performance.

Now turning to user-to-AI feedback, in a first example, a security team provides feedback that a scenario was too easy or unrealistic. The exemplary user-to-AI feedback may be a statement that “This ransomware scenario was too basic-our team has seen this before”. In response, the adversary AI can adjust future scenarios

Still referring to user-to-AI feedback, in a second example, the team identifies gaps in playbook procedures during scenario execution. The exemplary user-to-AI feedback may be a statement that “Our playbook doesn't cover cloud credential compromise scenarios”. In response, the AI generates recommendations for playbook improvements and creates scenarios specifically targeting identified gaps.

Also, the systems described herein can continuously update playbooks. Furthermore, teams can be continuously trained based on learnings from continuous exercising of the playbook content and team combined with real world evolving threat scenarios. This includes new threat patterns and attack vectors, effective response strategies and procedures and organizational learning and maturity progression.

The systems described herein have several key features for its continuous operation. First, the systems conduct asynchronous processing. That is, all steps performed by the systems can operate or be done independently and continuously. Second, the systems have event-driven architecture. This means that the systems respond to events in real-time. Third, the systems have a scalable design, so the systems can handle multiple teams and organizations simultaneously. Fourth, the systems utilize secure dynamic tenancy. That is, the systems can operate involving multiple organizations in a single exercise. Finally, the systems are all permissions-based and secured via the API. AI agents act as a user. Permissions are limited to what the AI agents are granted by humans.

It should also be noted that there are several feedback mechanisms that may be used in the systems described herein, namely:
Immediate Feedback: Real-time guidance during active scenarios
Short-term Feedback: Performance analysis and recommendations
Long-term Feedback: Strategic insights and organizational learning
Cross-Organizational Feedback: Best practice sharing and benchmarking

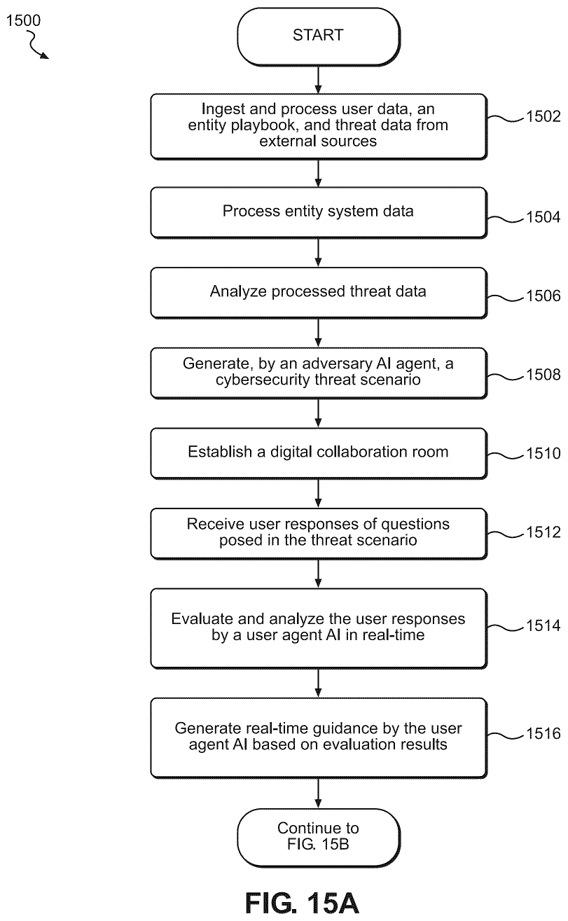

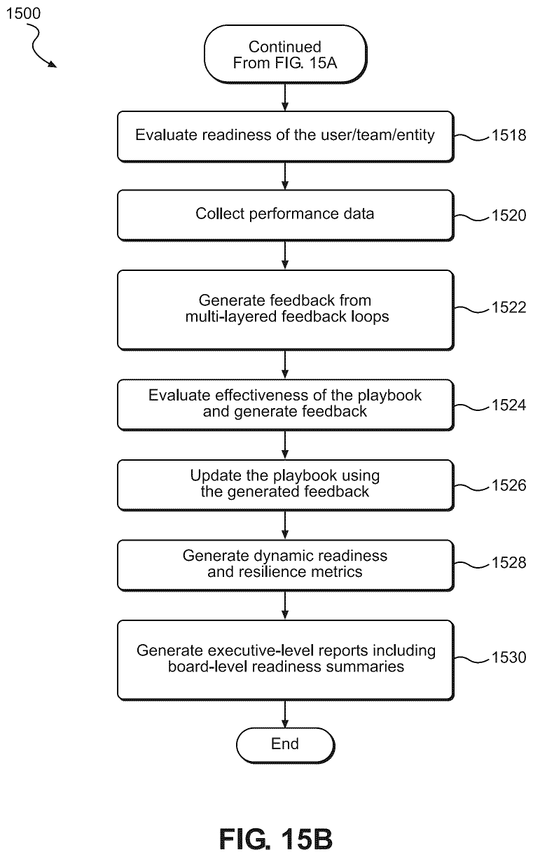

FIGS. 15A and 15B are flowcharts of an example method 1500 for providing continuous cybersecurity readiness, in accordance with an embodiment of the present disclosure. The method 1500 begins with a step 1502, when user data associated with the user, a playbook associated with the entity, and threat data obtained from external sources are ingested and processed by the system. At step 1504, entity system data is processed. In some embodiments, the entity system data can include several types of data. For instance, in SIEM data ingestion, the system processes Security Information and Event Management (SIEM) data including security event logs, network traffic logs, authentication logs, and system access logs. This data provides real-time visibility into the organization's security posture and ongoing activities.

In some embodiments, for asset inventory and network topology, the system processes organizational asset inventories including endpoint devices, servers, network devices, cloud resources, and their interconnections. This data enables scenario generation that targets specific organizational infrastructure and attack paths.

For user access patterns and permissions, the system analyzes user access patterns, authentication logs, and permission structures to understand organizational roles, responsibilities, and potential insider threat scenarios.

For historical incident data, the system processes historical security incident data including previous breaches, attempted attacks, and incident response outcomes to identify recurring patterns and areas for improvement.

For compliance and policy data, the system ingests organizational security policies, compliance requirements, and regulatory frameworks to ensure generated scenarios align with organizational governance requirements.

Utilizing operational technology (OT) Data, for organizations with industrial systems, the system processes OT network data, SCADA system information, and industrial control system configurations to generate relevant industrial cybersecurity scenarios.

One or more of the above-mentioned types of entity data are processed by the system in step 1504.

At step 1506, the system analyzes the processed threat data. At step 1508, based on the processed user data, the processed entity system data, the analysis of the processed threat data, and the processed playbook, an adversary AI agent generates a cybersecurity threat scenario that is customized for the user.

At step 1510 a digital collaboration room for an entity is established via an orchestration service. Further details about digital collaboration rooms are provided earlier herein, and in particular, an exemplary digital collaboration room is depicted in FIG. 1. The entity has control to grant permissions to users and artificial intelligence (AI) agents regarding the digital collaboration room. The entity also has the ability to dynamically modify permissions of the users and the AI agents. The orchestration service includes a cloud resource where the digital collaboration room, owned by the entity, is hosted and made accessible to the user and the AI agents. The AI agents may include the adversary AI agent and a user agent AI.

At step 1512, the system receives user responses to one or more questions that are posed in the threat scenario. At step 1514, the user responses are evaluated and analyzed by the user agent AI in real-time.

At step 1516, based on the evaluation results of the users' responses by the user agent AI, real-time guidance is generated also by the user agent AI. At step 1518, based on the AI evaluation and analysis of the user responses, the readiness of the user to respond to a cybersecurity threat is evaluated by the system. Alternatively, at step 1518, the readiness of a team associated with the user is evaluated by the system. Or, at step 1518, the readiness of the entity or sets of teams is evaluated by the system.

Then, at step 1520, performance data is collected. The performance data includes response time metrics and decision quality assessment. For response time metrics, the system collects detailed timing data including time to first response, time to containment, time to resolution, and time between decision points. This data enables performance benchmarking against industry standards and organizational SLAs. For decision quality assessment, the system tracks decision accuracy, completeness, and adherence to established procedures. The AI analyzes decision patterns to identify knowledge gaps, procedural weaknesses, and areas for improvement.

At step 1522, feedback is generated from multi-layered feedback loops. At step 1524, the effectiveness of the playbook is evaluated, and feedback is generated about the playbook. The feedback may be generated from one or more feedback loops between or among the AI agents and/or the users. At step 1526, the playbook of the entity is updated using the generated feedback. At step 1528, dynamic readiness and resilience metrics are generated and displayed. Finally, at step 1530, executive-level reports, including board-level readiness summaries, are generated and displayed.

FIG. 16 is an exemplary screenshot of a Chief Information Security Officer (CISO)'s readiness dashboard user interface 1600, in accordance with certain embodiments of the present disclosure. The exemplary user interface 1600 provides the organizational readiness score 1605, which includes a breakdown of how the system has calculated the organizational readiness score 1605. As shown in the exemplary user interface 1600, the breakdown may include the system's metrics of the playbook coverage (how much has the team's or organization's inputted playbook been tested), team coverage (how many of the team members participated in the drill), and drill performance (how well did the team members respond correctly to the drills, simulations, or scenarios that were generated by the system). In determining the metrics for drill performance, the system can look for certain keywords within team members' responses to drills, simulations, or scenarios, since team members may use different words or terms in their responses, all of which may be correct responses to the drill question posed.

Still referring to FIG. 16, the exemplary user interface 1600 also provides a system-generated list of the readiness program 1610. The list 1610 is automatically generated by the system and it provides information to the CISO of what should be tested in the form of milestones. The list 1610 provides the CISO with an understanding of what the system is trying to achieve. In FIG. 16, for instance, the list shows the next milestone is to “Run an executive level TTX”. The CISO can press the “Schedule TTX” button in order to schedule the tabletop.

Still referring to FIG. 16, the exemplary user interface 1600 also provides an exercise history 1615, which allows for the CISO to drill down into any exercise (e.g., drill, simulation or scenario) that has been completed, is scheduled, or is in progress. The type of exercise is also listed in the exercise history 1615. If the type is “CT” then the exercise type is a continuous tabletop.

Also, as shown in the exercise history 1615 depicted in FIG. 16, the CISO can view results, edit, or monitor a particular exercise. The exemplary user interface 1600 provides a dashboard for the CISO that includes the team's scores, the upcoming milestones in the form of a readiness program, the metrics, and a summary of what has been done thus far. The CISO can also schedule a continuous tabletop exercise by pressing an interface button 1620 that transmits this user command to the system.

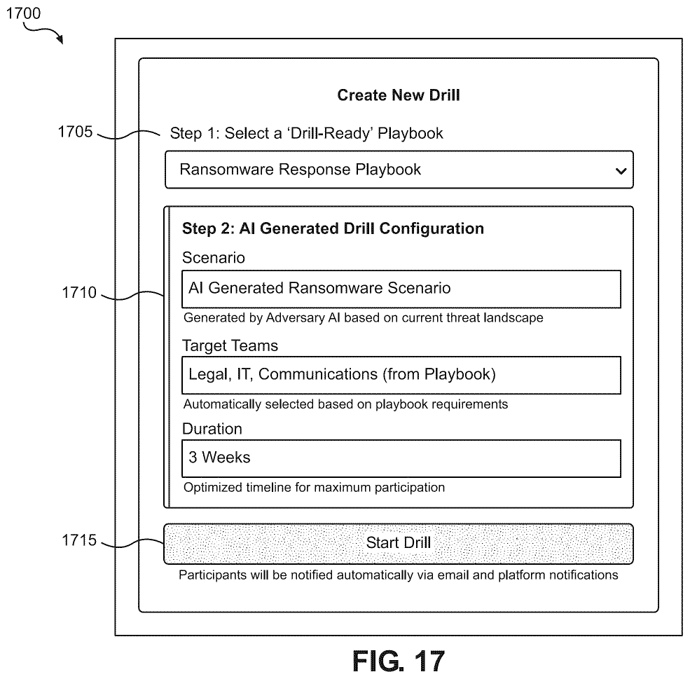

FIG. 17 is an exemplary screenshot of a graphical user interface 1700 that is displayed when a new drill is scheduled, in accordance with certain embodiments of the present disclosure. The graphical user interface 1700 includes a drop-down menu 1705 for the CISO or administrator to select a playbook from the organization's or entity's playbooks. In the example provided in FIG. 17, the CISO or administrator selected the “Ransomware Response Playbook.” The graphical user interface 1700 also includes automated configuration fields 1710, which provide the configurable parameters for the AI-generated drill. The configuration fields 1710 are automatically generated by the system based on the data provided by the playbook selected. In the example provided in FIG. 17, the scenario selected is an “AI Generated Ransomware Scenario” with the target teams being “Legal, IT, Communications (from Playbook)” and a duration of 3 weeks. In other words, the scenario will be an AI generated ransomware scenario that will be sent to the members of the legal, IT and communications teams, and the drill will have a duration of 3 weeks for the team members to participate in the drill. The CISO or administrator can begin the drill by clicking on a “Start Drill” button 1715 of the graphical user interface 1700.

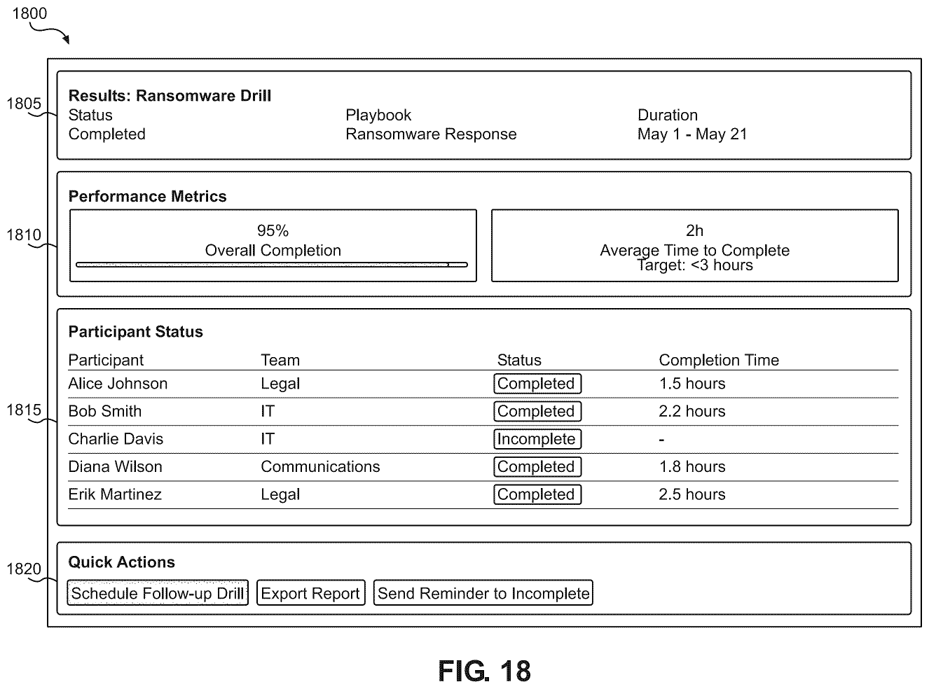

FIG. 18 is an exemplary screenshot of a graphical user interface 1800 that is displayed when results of a drill are viewed, in accordance with certain embodiments of the present disclosure. In the example provided in FIG. 18, a results dashboard 1805 of the graphical user interface 1800 shows that the drill session is completed, it was based on the Ransomware Response playbook, and the drill session ran from May 1 to May 21. The graphical user interface 1800 also shows performance metrics 1810, which in this example indicate that the overall completion of the drill was 95 percent and the average time for the team participants to complete the drill was 2 hours. The graphical user interface 1800 also shows, via a list of participant status 1815, the names and teams of the participants of the drill session, their status (complete or incomplete), and the completion time (the time it took a given participant to complete the drill session). In the example provided in FIG. 18, the list of participant status 1815 shows that Charlie Davis did not complete the drill. The CISO or administrator can select one or more buttons for a plurality of quick actions 1820. The CISO or administrator can select a button to “Schedule a Follow-up Drill” for any team member or for the entire team. The CISO or administrator can select a button to “Export Report” of the results of the drill. Also, the CISO or administrator can select a button to “Send Reminder to Incomplete” which means that in response to the selection, the system would send a reminder to those participants who did not complete the drill. In this example, the system would send a reminder to Charlie who did not complete the drill. The other remaining participants who did complete this drill may progress to another drill that is generated by the AI of the system.

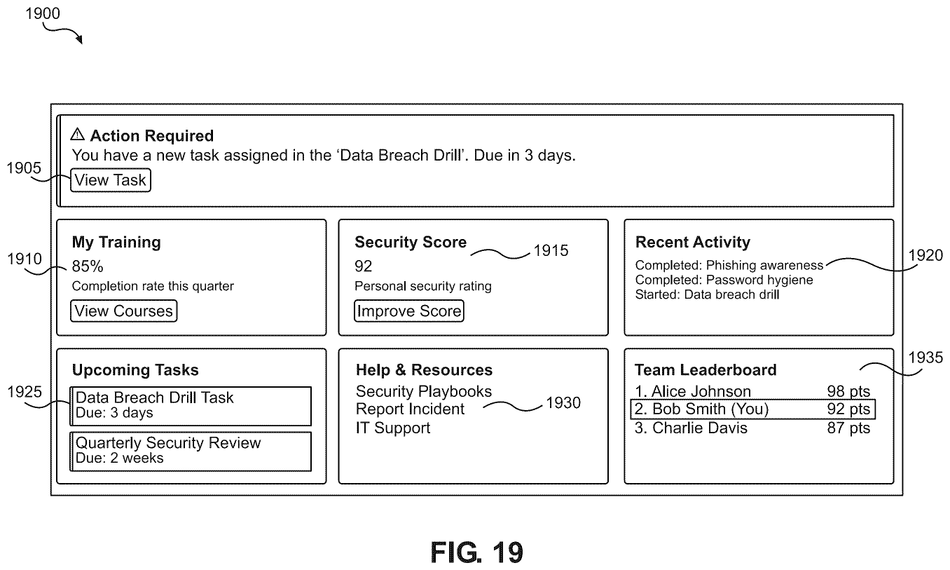

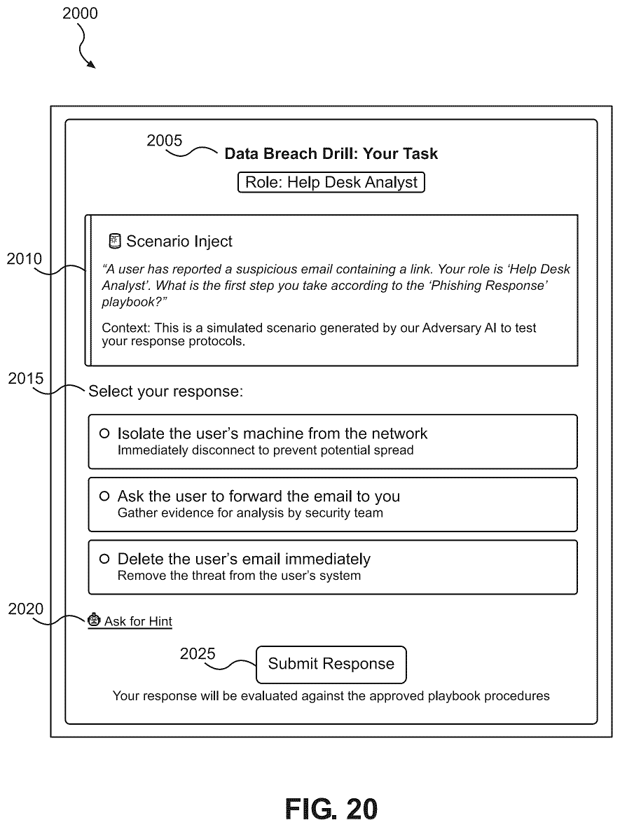

FIG. 19 is an exemplary screenshot of an end user (participant)'s dashboard user interface 1900, in accordance with certain embodiments of the present disclosure. The user interface 1900 displays that an action is required of the end user, and that to view the task, the user may click on a “View Task” button 1905. Once the user clicks on the “View Task” button 1905, the user will be presented with details of the AI-generated scenario that are created for the user. Those details are provided in FIG. 20, which will be described later herein.

Still referring to FIG. 19, in the My Training panel 1910 of the user interface 1900, the end user can view their completion rate of drills for this quarter. In the example provided in FIG. 19, the end user has a 85% completion rate, and if the end user presses the button underneath their completion rate, they can view the courses or drills they had participated in. The end user can also view their personal security score 1915 for this quarter, and if the end user presses the button underneath their security score 1915, the AI of the system can provide the end user with information on how to improve their security score.

Still referring to FIG. 19, in the Recent Activity panel 1920 of the user interface 1900, the end user can view which activities (including drills, scenarios, simulations, or exercises) they have completed or are in progress. In the Upcoming Tasks panel 1925, the end user can view their tasks and the due date associated with each of their tasks. In the Help & Resources panel 1930, the end user can access resources, such as security playbooks of the team, and the end user can request help by reporting an incident or requesting IT support. Finally, in the Team Leaderboard 1935 of the user interface 1900, a list of team members having the highest security scores are shown in descending order.

FIG. 20 is an exemplary screenshot of a graphical user interface 2000 that is displayed when an end user starts a drill, in accordance with certain embodiments of the present disclosure. As mentioned earlier, once the user clicks on the “View Task” button 1905 (FIG. 19), the user will be presented with the graphical user interface 2000 of FIG. 20. The graphical user interface 2000 provides a name 2005 of the AI-generated scenario or drill that is uniquely created specifically for the user. In the example provided in FIG. 20, the graphical user interface 2000 shows that the user's task is a data breach drill. The graphical user interface 2000 also shows a scenario inject 2010.

Finally, a system interaction occurs with the user. In a first embodiment, the graphical user interface 2000 provides the user multiple choice answers 2015. To answer the question posed by the AI in the data breach drill, the user is to select one of the multiple choice answers 2015. If necessary, the user can request the AI to help them, by clicking on the “Ask for Hint” button 2025. During the drill, the user has access to interact with an AI agent that can help the user to complete the test. Finally, once the user has selected one of the multiple choice answers 2015, they can submit their response by clicking on the “Submit Response” button 2025. This process continues until all the questions of the AI-generated scenario have been answered by the user.

Alternatively, in a second embodiment, instead of providing the user with multiple choice answers 2015 via the graphical user interface 2000, the system allows for the user to take an action within the collaboration room and the system will update based on the user using the collaboration room as they would in a real-life incident. That is, the user can interact with the collaboration room as they would an incident and then the agent AI can act as the drill facilitator to the user.

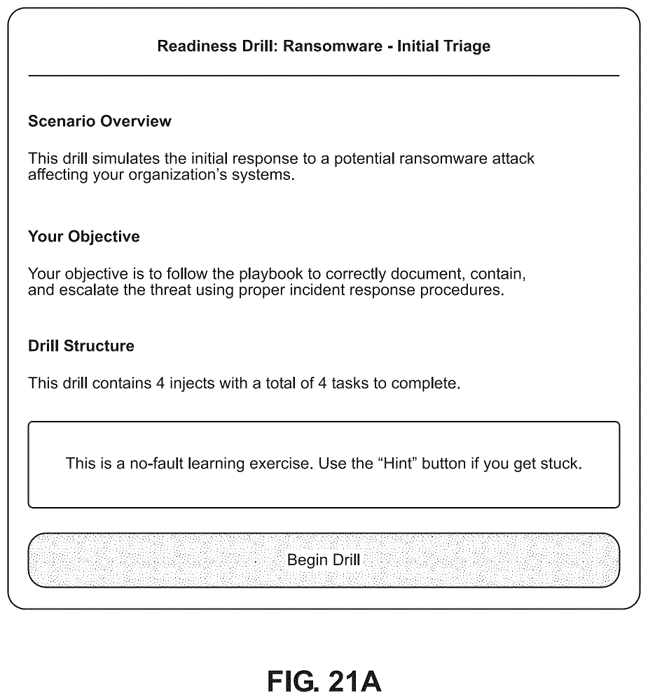

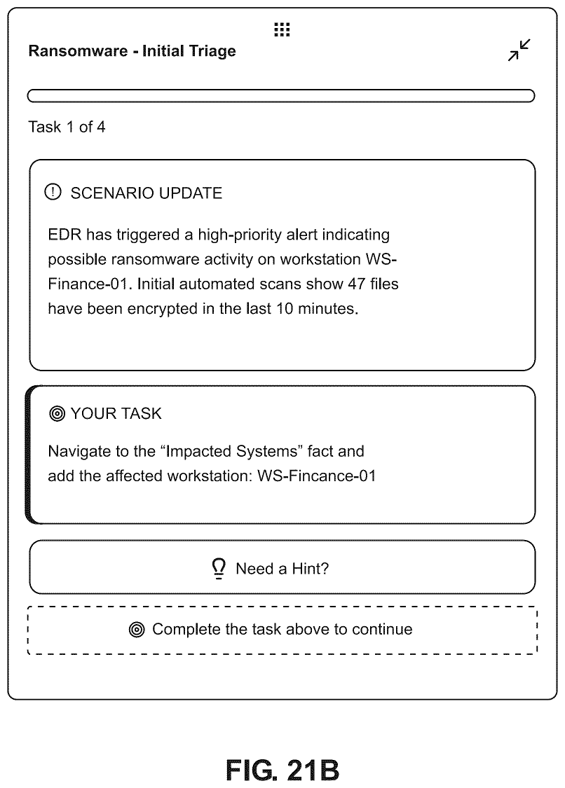

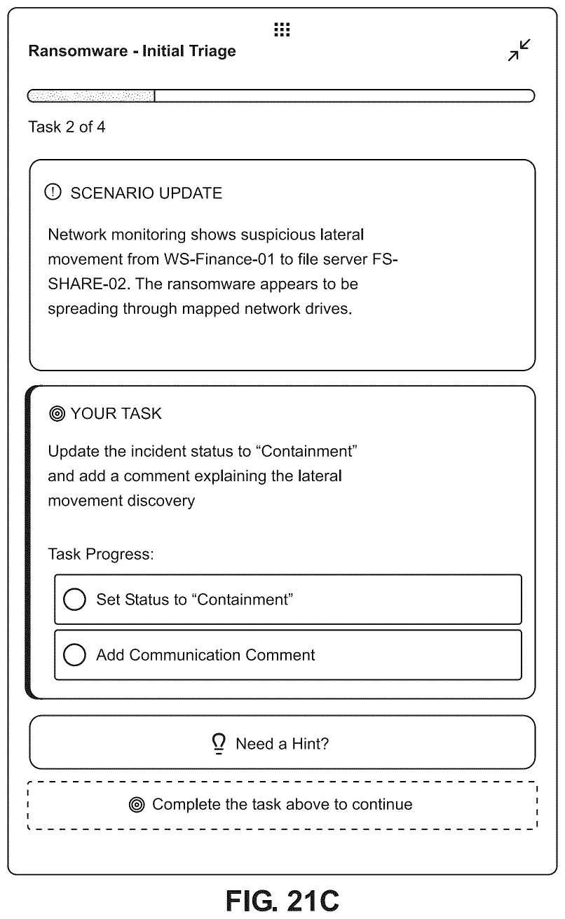

In one embodiment, upon a user entering the room, a virtual assistant will present the scenario. The virtual assistant may issue specific guidance on guiding the user or the virtual assistant may just present the scenario to the user. As the user interacts with the collaboration room, the virtual assistant updates and presents more of the scenario to the user. The action expected to be taken by the user in the collaboration room is in response to the threat scenario presented. FIGS. 21A, 21B and 21C are exemplary screenshots of a virtual assistant presenting a thread scenario to a user. Some of the actions that the user can take in the collaboration room include, but are not limited to, updating facts, performing tasks, messaging other users, having a call with other people on the team, and the like.

The systems and methods for continuous cybersecurity readiness can utilize any method steps, systems, or system components that are described earlier herein, including but not limited to those that are depicted in FIGS. 1 through 11B.

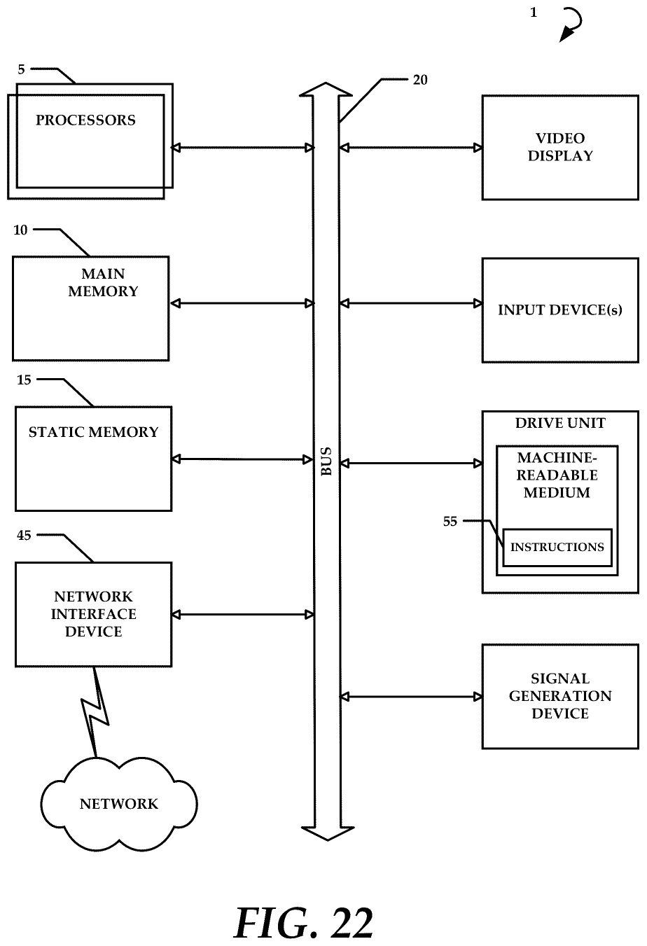

FIG. 22 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 are those typically found in computer systems that may be suitable for use with embodiments of the present disclosure and are intended to represent a broad category of such computer components that are well known in the art. Thus, the computer system 1 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for providing continuous cybersecurity readiness using artificial intelligence, comprising:
ingesting user data associated with the user and a playbook associated with an entity;
based on the user data and the playbook, generating, by an adversary AI agent, a cybersecurity threat scenario that is customized for the user;
establishing, via an orchestration service, a digital collaboration room for the entity, the entity having control to grant permissions to a user and artificial intelligence (AI) agents regarding the digital collaboration room and to dynamically modify permissions of the user and the AI agents, the orchestration service being a cloud resource where the digital collaboration room, owned by the entity, is hosted and made accessible to the user and the AI agents, the AI agents comprising the adversary AI agent and a user agent AI; receiving:
user responses to one or more questions posed in the threat scenario, or
user actions in the collaboration room in response to the threat scenario;
evaluating and analyzing the user responses or the user actions by the user agent AI in real-time;
based on the AI evaluation and analysis of the user responses or the user actions, evaluating readiness of the user to respond to a cybersecurity threat;
evaluating effectiveness of the playbook and generating feedback regarding the playbook, the feedback being generated from one or more feedback loops between the AI agents and the user; and
updating the playbook, the updating including incorporation of the generated feedback into the playbook.

2. The method according to claim 1, further comprising automatically generating, by the adversary AI, a new threat scenario in response to evolving threat intelligence obtained from external sources.

3. The method according to claim 1, wherein the adversary AI generates and adapts a thread scenario based on real-time threat intelligence, organizational context, and historical performance.

4. The method according to claim 1, wherein the user agent AI evaluates user and system responses and provides real-time scoring, feedback and guidance.

5. The method according to claim 1, wherein the adversary AI and the user agent AI operate autonomously.

6. The method according to claim 1, wherein the one or more feedback loops comprises feedback from an AI agent to a user to provide real-time guidance and recommendations.

7. The method according to claim 1, wherein the one or more feedback loops comprises feedback from the user agent AI to the adversary AI, such that the adversary AI heuristically learns from the user agent AI's evaluation results of the user responses.

8. The method according to claim 1, wherein the one or more feedback loops comprises feedback from the user to an AI agent, where the user's actions inform future scenario generation by the AI agent.

9. The method according to claim 1, further comprising continuous integrated tabletop and training operations.

10. A method for providing continuous cybersecurity readiness using artificial intelligence, comprising:
ingesting and processing user data associated with the user, a playbook associated with the entity, and threat data obtained from external sources;
analyzing processed threat data;
based on the user data and the playbook, generating, by the adversary AI agent, a cybersecurity threat scenario that is customized for the user;
establishing, via an orchestration service, a digital collaboration room for an entity, the entity having control to grant permissions to a user and artificial intelligence (AI) agents regarding the digital collaboration room and to dynamically modify permissions of the user and the AI agents, the orchestration service being a cloud resource where the digital collaboration room, owned by the entity, is hosted and made accessible to the user and the AI agents, the AI agents comprising an adversary AI agent and a user agent AI;
receiving:
user responses to one or more questions posed in the threat scenario, or
user actions in the collaboration room in response to the threat scenario;
evaluating and analyzing the user responses or the user actions by the user agent AI in real-time;
based on the AI evaluation and analysis of the user responses or the user actions, generating real-time guidance by the user agent AI;
evaluating readiness of the entity, the user, or a team associated with the user to respond to a cybersecurity threat;
generating feedback from multi-layered feedback loops;
evaluating effectiveness of the playbook and generating feedback regarding the playbook, the feedback being generated from one or more feedback loops of the multi-layered feedback looks; and
updating the playbook using the generated feedback.

11. The method according to claim 10, further comprising:
processing entity system data;
collecting performance data;
generating dynamic readiness and resilience metrics; and
generating executive-level reports including board-level readiness summaries.

12. A system comprising:
a processor and memory for storing executable instructions, the processor executing the instructions to:
ingest user data associated with a user and a playbook associated with the entity;
based on the user data and the playbook, generate, by an adversary AI agent, a cybersecurity threat scenario that is customized for the user;
establish, via an orchestration service, a digital collaboration room for an entity, the entity having control to grant permissions to a user and artificial intelligence (AI) agents regarding the digital collaboration room and to dynamically modify permissions of the user and the AI agents, the orchestration service being a cloud resource where the digital collaboration room, owned by the entity, is hosted and made accessible to the user and the AI agents, the AI agents comprising the adversary AI agent and a user agent AI;
receive:
user responses to one or more questions posed in the threat scenario, or
user actions in the collaboration room in response to the threat scenario;
evaluate and analyze the user responses or the user actions by the user agent AI in real-time;
based on the AI evaluation and analysis of the user responses or the user actions, evaluate readiness of the user to respond to a cybersecurity threat;
evaluate effectiveness of the playbook and generating feedback regarding the playbook, the feedback being generated from one or more feedback loops between the AI agent and the user; and
update the playbook, the updating including incorporation of the generated feedback into the playbook.

13. The system according to claim 12, wherein the processor is further configured to execute instructions to automatically generate, by the adversary AI, a new threat scenario in response to evolving threat intelligence obtained from external sources.

14. The system according to claim 12, wherein the adversary AI generates and adapts a thread scenario based on real-time threat intelligence, organizational context, and historical performance.

15. The system according to claim 12, wherein the user agent AI evaluates user and system responses and provides real-time scoring, feedback and guidance.

16. The system according to claim 12, wherein the adversary AI and the user agent AI operate autonomously.

17. The system according to claim 12, wherein the one or more feedback loops comprises feedback from an AI agent to a user to provide real-time guidance and recommendations.

18. The system according to claim 12, the one or more feedback loops comprises feedback from the user agent AI to the adversary AI, such that the adversary AI heuristically learns from the user agent AI's evaluation results of the user responses.

19. The system according to claim 12, wherein the one or more feedback loops comprises feedback from the user to an AI agent, where the user's actions inform future scenario generation by the AI agent.

20. The system according to claim 12, further comprising continuous integrated tabletop and training operations.
